(19) United States
(12) Patent Application Publication
(10) Pub. No.: US 2026/0194616 A1
(43) Pub. Date: Jul. 9, 2026

(54) DIFFERENTIAL DOPPLER BASED RF SENSING

(71) Applicant: QUALCOMM Incorporated, San Diego, CA (US)

(72) Inventors: Yuwei REN, Beijing (CN); Weimin DUAN, San Diego, CA (US); Huilin XU, Temecula, CA (US)

(21) Appl. No.: 19/132,611

(22) PCT Filed: Jan. 10, 2023
(86) PCT No.: PCT/CN2023/071493

§ 371 Date: May 23, 2025

(51) Int. Cl. G01S 5/02; G01S 13/87; H04B 7/04

(52) U.S. Cl. CPC G01S 5/0246; G01S 13/876; H04B 7/04013

(57) ABSTRACT

An example method of frequency difference of arrival (FDOA)-based sensing transmitting device, performed by a server, the method comprising transmitting, to the transmitting device, a FDOA-based sensing configuration, wherein the FDOA-based sensing configuration configures the transmitting device to transmit at a first, a second, and a third time points, a first, a second, and a third radio frequency (RF) signals respectively. The method also comprises obtaining a first FDOA measurement determined based on a reflection of the first RF signal and a reflection of the second RF signal, and a second FDOA measurement determined based on the reflection of the second RF signal and a reflection of the third RF signal. The method further comprises obtaining Doppler information of the reflector, and obtaining Doppler information of the transmitting device based on the first FDOA measurement and the second FDOA measurement, and the Doppler information of the reflector.

### BACKGROUND

### 1. Field of Disclosure

The present disclosure relates generally to the field of wireless communications, and more specifically to determining Doppler information of a target using radio frequency (RF) signals.

### 2. Description of Related Art

The sensing of a target (e.g., an RF device or an object being able to reflect RF signals) can have a wide range of consumer, industrial, commercial, military, and other applications. Different from Time Difference of Arrival (TDOA)-based sensing, the Time Difference of Arrival (FDOA)-based sensing determines the Doppler information of the target based on the Doppler shift of the RF signal caused by disparities between the receiver and emitter velocities.

### BRIEF SUMMARY

An example method of frequency difference of arrival (FDOA)-based sensing transmitting device, performed by a server, the method comprising transmitting, to the transmitting device, a FDOA-based sensing configuration, wherein the FDOA-based sensing configuration configures the transmitting device to: transmit at a first time point, a first radio frequency (RF) signal; transmit at a second time point, a second RF signal; and transmit at a third time point, a third RF signal. The method also comprises obtaining a first FDOA measurement determined based on a reflection of the first RF signal and a reflection of the second RF signal, and a second FDOA measurement determined based on the reflection of the second RF signal and a reflection of the third RF signal, wherein the reflections of the first, the second, and the third RF signals are reflected by a reflector and received at a receiving device. The method further comprises obtaining Doppler information of the reflector, and obtaining Doppler information of the transmitting device based on the first FDOA measurement and the second FDOA measurement, and the Doppler information of the reflector.

An example method of frequency difference of arrival (FDOA)-based sensing for a transmitting device performed by a receiving device, the method comprising receiving at a first time point, a reflection of a first radio frequency (RF) signal transmitted by the transmitting device and receiving at a second time point, a reflection of a second RF signal transmitted by the transmitting device. The method also comprises receiving at a third time point, a reflection of a third RF signal transmitted by the transmitting device and determining frequency offsets of the reflections of the first RF signal, the second RF signal, and the third RF signal. The method further comprises determining a first FDOA measurement determined based on the frequency offset of the reflection of the first RF signal and the frequency offset of the reflection of the second RF signal, and a second FDOA measurement determined based on the frequency offset of the reflection of the second RF signal and the frequency offset of the reflection of the third RF signal.

An example server for frequency difference of arrival (FDOA)-based sensing of a target, the server comprising a transceiver, a memory, and one or more processors communicatively coupled with the transceiver and the memory. The one or more processors are configured to transmit, to the transmitting device, a FDOA-based sensing configuration, wherein the FDOA-based sensing configuration configures the transmitting device to: transmit at a first time point, a first radio frequency (RF) signal, transmit at a second time point, a second RF signal, and transmit at a third time point, a third RF signal. The one or more processors are also configured to obtain a first FDOA measurement determined based on a reflection of the first RF signal and a reflection of the second RF signal, and a second FDOA measurement determined based on the reflection of the second RF signal and a reflection of the third RF signal, wherein the reflections of the first, the second, and the third RF signals are reflected by a reflector and received at a receiving device. The one or more processors are further configured to obtain Doppler information of the reflector and obtain Doppler information of the transmitting device based on the first FDOA measurement and the second FDOA measurement, and the Doppler information of the reflector.

An example device for frequency difference of arrival (FDOA)-based sensing of a target, the device comprising a transceiver, a memory, and one or more processors communicatively coupled with the transceiver and the memory. The one or more processors are configured to receive at a first time point, a reflection of a first radio frequency (RF) signal transmitted by the transmitting device and receive at a second time point, a reflection of a second RF signal transmitted by the transmitting device. The one or more processors are further configured to receive at a third time point, a reflection of a third RF signal transmitted by the transmitting device and determine frequency offsets of the reflections of the first RF signal, the second RF signal, and the third RF signal. The one or more processors are further configured to determine a first FDOA measurement determined based on the frequency offset of the reflection of the first RF signal and the frequency offset of the reflection of the second RF signal, and a second FDOA measurement determined based on the frequency offset of the reflection of the second RF signal and the frequency offset of the reflection of the third RF signal.

The foregoing, together with other features and examples, will be described in more detail below in the following specification, claims, and accompanying drawings.

### BRIEF DESCRIPTION OF THE DRAWINGS

FIG. 1 is an illustration of a communication/positioning/sensing system, according to an embodiment.

FIG. 2 is diagram of a fifth-generation new radio (5G NR) network, according to an embodiment.

FIG. 3 is a diagram showing geometry of an example of FDOA-based sensing may and associated terminology.

FIG. 4 is a diagram showing an example an example of oscillator error in a frequency offset measurement of a FDOA-based sensing and associated terminology.

FIG. 5 is a diagram showing an example of how an improved FDOA-based sensing for sensing a target may be performed and associated geometry, according to some embodiments.

FIG. 6 is a flow diagram illustrating how the improved FDOA-based sensing for sensing a target may be performed in a bi-static setting, according to some embodiments.

FIG. 7 is a diagram showing an example of how an improved FDOA-based sensing for sensing a target may be performed in a multi-static setting, according to some embodiments, according to some embodiments.

FIG. 8 is a diagram showing an example of how an improved FDOA-based sensing for sensing a transmitting device may be performed, according to some embodiments.

FIG. 9 is a flow diagram illustrating how the improved FDOA-based sensing for sensing a transmitting device may be performed, according to some embodiments.

FIG. 10 is a method of improved FDOA-based sensing of a target performed by a transmitting device, according to some embodiments.

FIG. 11 is a method of improved FDOA-based sensing of a target performed by a server, according to some embodiments.

FIG. 12 is a method of improved FDOA-based sensing of a transmitting device performed by a transmitting device, according to some embodiments.

FIG. 13 is a method of improved FDOA-based sensing of a transmitting device by a server, according to some embodiments.

FIG. 14 is a block diagram of an embodiment of a computer system, which can be utilized in embodiments as described herein.

FIG. 15 is a block diagram of an embodiment of a base station, which can be utilized in embodiments as described herein.

Like reference symbols in the various drawings indicate like elements, in accordance with certain example implementations. In addition, multiple instances of an element may be indicated by following a first number for the element with a letter or a hyphen and a second number. For example, multiple instances of an element 110 may be indicated as 110-1, 110-2, 110-3 etc. or as 110a, 110b, 110c, etc. When referring to such an element using only the first number, any instance of the element is to be understood (e.g., element 110 in the previous example would refer to elements 110-1, 110-2, and 110-3 or to elements 110a, 110b, and 110c).

### DETAILED DESCRIPTION

The following description is directed to certain implementations for the purposes of describing innovative aspects of various embodiments. However, a person having ordinary skill in the art will readily recognize that the teachings herein can be applied in a multitude of different ways. The described implementations may be implemented in any device, system, or network that is capable of transmitting and receiving radio frequency (RF) signals according to any communication standard, such as any of the Institute of Electrical and Electronics Engineers (IEEE) 802.15.4 standards for ultra-wideband (UWB), IEEE 802.11 standards (including those identified as Wi-Fi® technologies), the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Rate Packet Data (HRPD), High Speed Packet Access (HSPA), High Speed Downlink Packet Access (HSDPA), High Speed Uplink Packet Access (HSUPA), Evolved High Speed Packet Access (HSPA+), Long Term Evolution (LTE), Advanced Mobile Phone System (AMPS), or other known signals that are used to communicate within a wireless, cellular or internet of things (IoT) network, such as a system utilizing 3G, 4G, 5G, 6G, or further implementations thereof, technology.

As used herein, an “RF signal” comprises an electromagnetic wave that transports information through the space between a transmitter (or transmitting device or emitter) and a receiver (or receiving device). As used herein, a transmitter may transmit a single “RF signal” or multiple “RF signals” to a receiver. However, the receiver may receive multiple “RF signals” corresponding to each transmitted RF signal due to the propagation characteristics of RF signals through multiple channels or paths.

Additionally, unless otherwise specified, references to “reference signals,” “positioning reference signals,” “reference signals for positioning,” and the like may be used to refer to signals used for positioning of a user equipment (UE). As described in more detail herein, such signals may comprise any of a variety of signal types but may not necessarily be limited to a Positioning Reference Signal (PRS) as defined in relevant wireless standards.

Further, unless otherwise specified, the term “sensing” and/or “positioning” as used herein may refer to absolute location determination, relative location determination, ranging, or a combination thereof. Such sensing and/or positioning may include and/or be based on timing, angular, phase, or power measurements, or a combination thereof (which may include RF sensing measurements) for the purpose of location or sensing services. Additionally or alternatively, the sensing used herein may also refer to Doppler information determination (e.g., motion determination).

Time difference of arrival (TDOA)-based, and frequency difference of arrival (FDOA)-based measurements are often used for target sensing. While the TDOA is related to the distance between the emitter and the receiver, the FDOA is caused by the Doppler shift of the signal due to disparities between receiver and emitter velocities. However, the nonlinearity and corresponding complicated geometry of the FDOA equations make FDOA less studied than the TDOA cases. While the FDOA measurements are often used as an additional constraint to the TDOA-based methods, in practice, there are cases where it is desirable to solve for the emitter location using FDOA only. For instance, in the case of a narrowband signal with a long pulse duration, the Doppler resolution is higher than the range resolution and it can be difficult to measure the TDOA accurately. Moreover, FDOA-based sensing can estimate the Doppler information (e.g., the motion) of the target besides the position. FDOA-based sensing can also avoid the error accumulation caused by the Doppler shift.

As will be discussed in detail below, when determining the FDOA measurements, the measured frequency offset includes not only the Doppler shift but also sometimes sizable oscillator error from both the emitter and the receiver. Especially when using a user equipment (UE) as the receiving device (e.g., the device that receives the RF signal and measures the frequency offsets), because the oscillators used by the UE are often not temperature controlled, the oscillator error in the generated frequency introduced by the receiver is non-neglectable and varies throughout the day depending on the temperature.

The technical solutions disclosed herein provide improved FDOA-based sensing that can obtain accurate Doppler shift estimates by removing the estimation bias caused by the UE oscillator error from the frequency offset estimates.

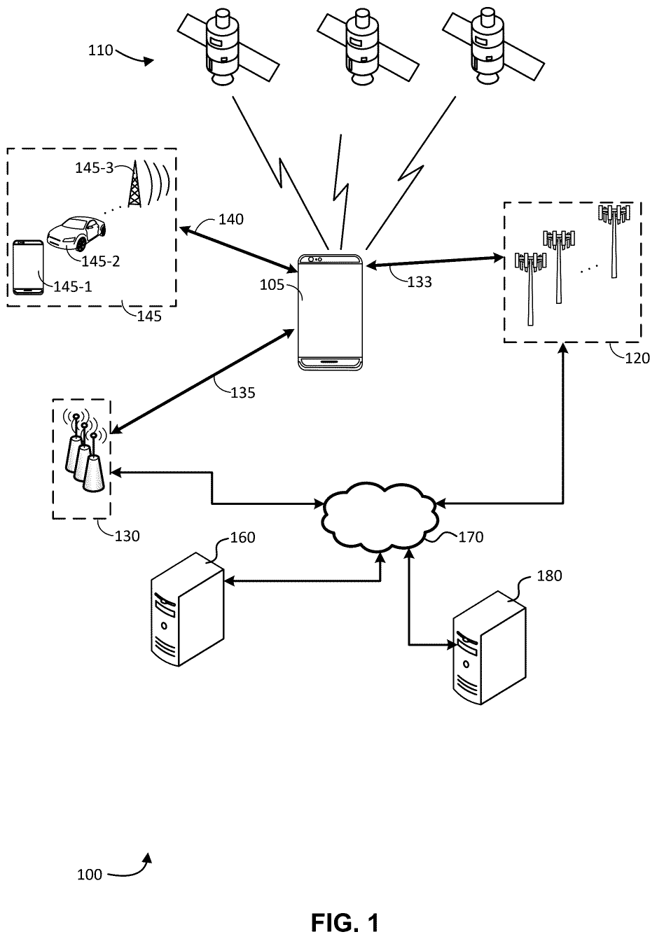

FIG. 1 is a simplified illustration of a wireless system capable of communication, positioning, and sensing, referred to herein as a “communication/positioning/sensing system” 100 in which a mobile device 105, network function server 160, and/or other components of the communication/positioning/sensing system 100 can use the techniques provided herein for RF sensing-according to an embodiment. (That said, embodiments are not necessarily limited to such a system.) The techniques described herein may be implemented by one or more components of the communication/positioning/sensing system 100. The communication/positioning/sensing system 100 can include: a mobile device 105; one or more satellites 110 (also referred to as space vehicles (SVs)), which may include Global Navigation Satellite System (GNSS) satellites (e.g., satellites of the Global Positioning System (GPS), GLONASS, Galileo, Beidou, etc.) and or Non-Terrestrial Network (NTN) satellites; base stations 120; access points (APs) 130; network function server 160; network 170; and external client 180. Generally put, the communication/positioning/sensing system 100 may be capable of enabling communication between the mobile device 105 and other devices, positioning of the mobile device 105 and/or other devices, performing RF sensing by the mobile device 105 and/or other devices, or a combination thereof. For example, the communication/positioning/sensing system 100 can estimate a location of the mobile device 105 based on RF signals received by and/or sent from the mobile device 105 and known locations of other components (e.g., GNSS satellites 110, base stations 120, APs 130) transmitting and/or receiving the RF signals. Additionally or alternatively, wireless devices such as the mobile device 105, base stations 120, and satellites 110 (and/or other NTN platforms, which may be implemented on airplanes, drones, balloons, etc.) can be utilized to perform positioning (e.g., of one or more wireless devices) and/or perform RF sensing (e.g., of one or more objects by using RF signals transmitted by one or more wireless devices).

It should be noted that FIG. 1 provides only a generalized illustration of various components, any or all of which may be utilized as appropriate, and each of which may be duplicated as necessary. Specifically, although only one mobile device 105 is illustrated, it will be understood that many UEs (e.g., hundreds, thousands, millions, etc.) may utilize the communication/positioning/sensing system 100. Similarly, the communication/positioning/sensing system 100 may include a larger or smaller number of base stations 120 and/or APs 130 than illustrated in FIG. 1. The illustrated connections that connect the various components in the communication/positioning/sensing system 100 comprise data and signaling connections which may include additional (intermediary) components, direct or indirect physical and/or wireless connections, and/or additional networks. Furthermore, components may be rearranged, combined, separated, substituted, and/or omitted, depending on desired functionality. In some embodiments, for example, the external client 180 may be directly connected to network function server 160. A person of ordinary skill in the art will recognize many modifications to the components illustrated.

Depending on desired functionality, the network 170 may comprise any of a variety of wireless and/or wireline networks. The network 170 can, for example, comprise any combination of public and/or private networks, local and/or wide-area networks, and the like. Furthermore, the network 170 may utilize one or more wired and/or wireless communication technologies. In some embodiments, the network 170 may comprise a cellular or other mobile network, a wireless local area network (WLAN), a wireless wide-area network (WWAN), and/or the Internet, for example. Examples of network 170 include a Long-Term Evolution (LTE) wireless network, a Fifth Generation (5G) wireless network (also referred to as New Radio (NR) wireless network or 5G NR wireless network), a Wi-Fi WLAN, and the Internet. LTE, 5G and NR are wireless technologies defined, or being defined, by the 3rd Generation Partnership Project (3GPP). In and LTE, 5G, or other cellular network, mobile device 105 may be referred to as a user equipment (UE). Network 170 may also include more than one network and/or more than one type of network.

The base stations 120 and access points (APs) 130 may be communicatively coupled to the network 170. In some embodiments, the base station 120s may be owned, maintained, and/or operated by a cellular network provider, and may employ any of a variety of wireless technologies, as described herein below. Depending on the technology of the network 170, a base station 120 may comprise a node B, an Evolved Node B (eNodeB or eNB), a base transceiver station (BTS), a radio base station (RBS), an NR NodeB (gNB), a Next Generation eNB (ng-eNB), or the like. A base station 120 that is a gNB or ng-eNB may be part of a Next Generation Radio Access Network (NG-RAN) which may connect to a 5G Core Network (5GC) in the case that Network 170 is a 5G network. The functionality performed by a base station 120 in earlier-generation networks (e.g., 3G and 4G) may be separated into different functional components (e.g., radio units (RUS), distributed units (DUs), and central units (CUs)) and layers (e.g., L1/L2/L3) in view Open Radio Access Networks (O-RAN) and/or Virtualized Radio Access Network (V-RAN or vRAN) in 5G or later networks, which may be executed on different devices at different locations connected, for example, via fronthaul, midhaul, and backhaul connections. As referred to herein, a “base station” (or ng-eNB, gNB, etc.) may include any or all of these functional components. An AP 130 may comprise a Wi-Fi AP or a Bluetooth® AP or an AP having cellular capabilities (e.g., 4G LTE and/or 5G NR), for example. Thus, mobile device 105 can send and receive information with network-connected devices, such as network function server 160, by accessing the network 170 via a base station 120 using a first communication link 133. Additionally or alternatively, because APs 130 also may be communicatively coupled with the network 170, mobile device 105 may communicate with network-connected and Internet-connected devices, including network function server 160, using a second communication link 135, or via one or more other mobile devices 145.

As used herein, the term “base station” may generically refer to a single physical transmission point, or multiple co-located physical transmission points, which may be located at a base station 120. A Transmission Reception Point (TRP) (also known as transmit/receive point) corresponds to this type of transmission point, and the term “TRP” may be used interchangeably herein with the terms “gNB,” “ng-eNB,” and “base station.” In some cases, a base station 120 may comprise multiple TRPs—e.g. with each TRP associated with a different antenna or a different antenna array for the base station 120. As used herein, the transmission functionality of a TRP may be performed with a transmission point (TP) and/or the reception functionality of a TRP may be performed by a reception point (RP), which may be physically separate or distinct from a TP. That said, a TRP may comprise both a TP and an RP. Physical transmission points may comprise an array of antennas of a base station 120 (e.g., as in a Multiple Input-Multiple Output (MIMO) system and/or where the base station employs beamforming). According to aspects of applicable 5G cellular standards, a base station 120 (e.g., gNB) may be capable of transmitting different “beams” in different directions, and performing “beam sweeping” in which a signal is transmitted in different beams, along different directions (e.g., one after the other). The term “base station” may additionally refer to multiple non-co-located physical transmission points, the physical transmission points may be a Distributed Antenna System (DAS) (a network of spatially separated antennas connected to a common source via a transport medium) or a Remote Radio Head (RRH) (a remote base station connected to a serving base station).

Satellites 110 may be utilized for positioning in communication in one or more way. For example, satellites 110 (also referred to as space vehicles (SVs)) may be part of a Global Navigation Satellite System (GNSS) such as the Global Positioning System (GPS), GLONASS, Galileo or Beidou. Positioning using RF signals from GNSS satellites may comprise measuring multiple GNSS signals at a GNSS receiver of the mobile device 105 to perform code-based and/or carrier-based positioning, which can be highly accurate. Additionally or alternatively, satellites 110 may be utilized for NTN-based positioning, in which satellites 110 may functionally operate as TRPs (or TPs) of a network (e.g., LTE and/or NR network) and may be communicatively coupled with network 170. In particular, reference signals (e.g., PRS) transmitted by satellites 110 NTN-based positioning may be similar to those transmitted by base stations 120, and may be coordinated by a network function server 160, which may operate as a location server. In some embodiments, satellites 110 used for NTN-based positioning may be different than those used for GNSS-based positioning. In some embodiments NTN nodes may include non-terrestrial vehicles such as airplanes, balloons, drones, etc., which may be in addition or as an alternative to NTN satellites. NTN satellites 110 and/or other NTN platforms may be further leveraged to perform RF sensing. As described in more detail hereafter, satellites may use a JCS symbol in an OFDM waveform to allow both RF sensing and communication.

The network function server 160 may comprise one or more servers and/or other computing devices configured to provide a network-managed and/or network-assisted function, such as operating as a location server and/or sensing server. A location server, for example, may determine an estimated location of mobile device 105 and/or provide data (e.g., “assistance data”) to mobile device 105 to facilitate location measurement and/or location determination by mobile device 105. According to some embodiments, a location server may comprise a Home Secure User Plane Location (SUPL) Location Platform (H-SLP), which may support the SUPL user plane (UP) location solution defined by the Open Mobile Alliance (OMA) and may support location services for mobile device 105 based on subscription information for mobile device 105 stored in the location server. In some embodiments, the location server may comprise, a Discovered SLP (D-SLP) or an Emergency SLP (E-SLP). The location server may also comprise an Enhanced Serving Mobile Location Center (E-SMLC) that supports location of mobile device 105 using a control plane (CP) location solution for LTE radio access by mobile device 105. The location server may further comprise a Location Management Function (LMF) that supports location of mobile device 105 using a control plane (CP) location solution for NR or LTE radio access by mobile device 105.

Similarly, the network function server 160, may function as a sensing server. A sensing server can be used to coordinate and/or assist in the coordination of sensing of one or more objects (also referred to herein as “targets”) by one or more wireless devices in the communication/positioning/sensing system 100. This can include the mobile device 105, base stations 120, APs 130, other mobile devices 145, satellites 110, or any combination thereof. Wireless devices capable of performing RF sensing may be referred to herein as “sensing nodes.” To perform RF sensing, a sensing server may coordinate sensing sessions in which one or more RF sensing nodes may perform RF sensing by transmitting RF signals (e.g., reference signals (RSs)), and measuring reflected signals, or “echoes,” comprising reflections of the transmitted RF signals off of one or more objects/targets. Reflected signals and object/target detection may be determined, for example, from channel state information (CSI) received at a receiving device. Sensing may comprise (i) monostatic sensing using a single device as a transmitter (of RF signals) and receiver (of reflected signals); (ii) bistatic sensing using a first device as a transmitter and a second device as a receiver; or (iii) multi-static sensing using a plurality of transmitters and/or a plurality of receivers. To facilitate sensing (e.g., in a sensing session among one or more sensing nodes), a sensing server may provide data (e.g., “assistance data”) to the sensing nodes to facilitate RS transmission and/or measurement, object/target detection, or any combination thereof. Such data may include an RS configuration indicating which resources (e.g., time and/or frequency resources) may be used (e.g., in a sensing session) to transmit RS for RF sensing. According to some embodiments, a sensing server may comprise a Sensing Management Function (SMF).

Although terrestrial components such as APs 130 and base stations 120 may be fixed, embodiments are not so limited. Mobile components may be used. For example, in some embodiments, a location of the mobile device 105 may be estimated at least in part based on measurements of RF signals 140 communicated between the mobile device 105 and one or more other mobile devices 145, which may be mobile or fixed. As illustrated, other mobile devices may include, for example, a mobile phone 145-1, vehicle 145-2, static communication/positioning device 145-3, or other static and/or mobile device capable of providing wireless signals used for positioning the mobile device 105, or a combination thereof. Wireless signals from mobile devices 145 used for positioning of the mobile device 105 may comprise RF signals using, for example, Bluetooth® (including Bluetooth Low Energy (BLE)), IEEE 802.11x (e.g., Wi-Fi®), Ultra Wideband (UWB), IEEE 802.15x, or a combination thereof. Mobile devices 145 may additionally or alternatively use non-RF wireless signals for positioning of the mobile device 105, such as infrared signals or other optical technologies.

An estimated location of mobile device 105 can be used in a variety of applications—e.g., to assist direction finding or navigation for a user of mobile device 105 or to assist another user (e.g., associated with external client 180) to locate mobile device 105. A “location” is also referred to herein as a “location estimate”, “estimated location”, “location”, “position”, “position estimate”, “position fix”, “estimated position”, “location fix” or “fix”. The process of determining a location may be referred to as “positioning,” “position determination,” “location determination,” or the like. A location of mobile device 105 may comprise an absolute location of mobile device 105 (e.g. a latitude and longitude and possibly altitude) or a relative location of mobile device 105 (e.g. a location expressed as distances north or south, east or west and possibly above or below some other known fixed location (including, e.g., the location of a base station 120 or AP 130) or some other location such as a location for mobile device 105 at some known previous time, or a location of a mobile device 145 (e.g., another UE) at some known previous time). A location may be specified as a geodetic location comprising coordinates which may be absolute (e.g., latitude, longitude and optionally altitude), relative (e.g., relative to some known absolute location) or local (e.g., X, Y and optionally Z coordinates according to a coordinate system defined relative to a local area such a factory, warehouse, college campus, shopping mall, sports stadium or convention center). A location may instead be a civic location and may then comprise one or more of a street address (e.g., including names or labels for a country, state, county, city, road and/or street, and/or a road or street number), and/or a label or name for a place, building, portion of a building, floor of a building, and/or room inside a building etc. A location may further include an uncertainty or error indication, such as a horizontal and possibly vertical distance by which the location is expected to be in error or an indication of an area or volume (e.g., a circle or ellipse) within which mobile device 105 is expected to be located with some level of confidence (e.g., 95% confidence).

The external client 180 may be a web server or remote application that may have some association with mobile device 105 (e.g., may be accessed by a user of mobile device 105) or may be a server, application, or computer system providing a location service to some other user or users which may include obtaining and providing the location of mobile device 105 (e.g. to enable a service such as friend or relative finder, or child or pet location). Additionally or alternatively, the external client 180 may obtain and provide the location of mobile device 105 to an emergency services provider, government agency, etc.

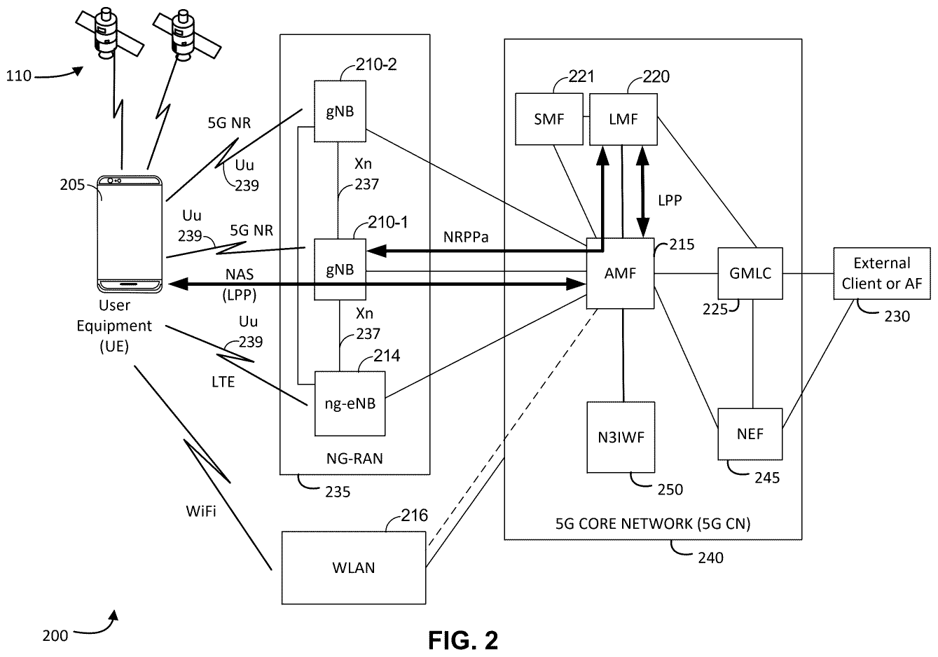

As previously noted, the example communication/positioning/sensing system 100 can be implemented using a wireless communication network, such as an LTE-based or 5G NR-based network, or a future 6G network. FIG. 2 shows a diagram of a 5G NR network 200, illustrating an embodiment of a wireless system (e.g., communication/positioning/sensing system 100) implemented in 5G NR. The 5G NR network 200 may be configured to enable wireless communication, determine the location of a UE 205 (which may correspond to the mobile device 105 of FIG. 1), perform RF sensing, or a combination thereof, by using access nodes, which may include NR NodeB (gNB) 210-1 and 210-2 (collectively and generically referred to herein as gNBs 210), ng-eNB 214, and/or WLAN 216. These access nodes can use RF signaling to enable the communication, implement one or more positioning methods, and/or implement RF sensing. The gNBs 210 and/or the ng-eNB 214 may correspond with base stations 120 of FIG. 1, and the WLAN 216 may correspond with one or more access points 130 of FIG. 1. Optionally, the 5G NR network 200 additionally may be configured to determine the location of a UE 205 by using an LMF 220 (which may correspond with location server 160) to implement the one or more positioning methods. The SMF 221 may coordinate RF sensing by the 5G NR network 200. Here, the 5G NR network 200 comprises a UE 205, and components of a 5G NR network comprising a Next Generation (NG) Radio Access Network (RAN) (NG-RAN) 235 and a 5G Core Network (5G CN) 240. A 5G NR network 200 may also be called a 5G network and/or an NR network; NG-RAN 235 may be referred to as a 5G RAN or as an NR RAN; and 5G CN 240 may be referred to as an NG Core network. Additional components of the 5G NR network 200 are described below. The 5G NR network 200 may include additional or alternative components.

The 5G NR network 200 may further utilize information from satellites 110. As previously indicated, satellites 110 may comprise GNSS satellites from a GNSS system like Global Positioning System (GPS) or similar system (e.g. GLONASS, Galileo, Beidou, Indian Regional Navigational Satellite System (IRNSS)). Additionally or alternatively, satellites 110 may comprise NTN satellites that may be communicatively coupled with the LMF 220 and may operatively function as a TRP (or TP) in the NG-RAN 235. As such, satellites 110 may be in communication with one or more gNB 210.

It should be noted that FIG. 2 provides only a generalized illustration of various components, any or all of which may be utilized as appropriate, and each of which may be duplicated or omitted as necessary. Specifically, although only one UE 205 is illustrated, it will be understood that many UEs (e.g., hundreds, thousands, millions, etc.) may utilize the 5G NR network 200. Similarly, the 5G NR network 200 may include a larger (or smaller) number of satellites 110, gNBs 210, ng-eNBs 214, Wireless Local Area Networks (WLANs) 216, Access and mobility Management Functions (AMF) s 215, external clients 230, and/or other components. The illustrated connections that connect the various components in the 5G NR network 200 include data and signaling connections which may include additional (intermediary) components, direct or indirect physical and/or wireless connections, and/or additional networks. Furthermore, components may be rearranged, combined, separated, substituted, and/or omitted, depending on desired functionality.

The UE 205 may comprise and/or be referred to as a device, a mobile device, a wireless device, a mobile terminal, a terminal, a mobile station (MS), a Secure User Plane Location (SUPL)-Enabled Terminal (SET), or by some other name. Moreover, UE 205 may correspond to a cellphone, smartphone, laptop, tablet, personal data assistant (PDA), navigation device, Internet of Things (IoT) device, or some other portable or moveable device. Typically, though not necessarily, the UE 205 may support wireless communication using one or more Radio Access Technologies (RATs) such as using GSM, CDMA, W-CDMA, LTE, High Rate Packet Data (HRPD), IEEE 802.11 Wi-Fi®, Bluetooth, Worldwide Interoperability for Microwave Access (WiMAX™), 5G NR (e.g., using the NG-RAN 235 and 5G CN 240), etc. The UE 205 may also support wireless communication using a WLAN 216 which (like the one or more RATs, and as previously noted with respect to FIG. 1) may connect to other networks, such as the Internet. The use of one or more of these RATs may allow the UE 205 to communicate with an external client 230 (e.g., via elements of 5G CN 240 not shown in FIG. 2, or possibly via a Gateway Mobile Location Center (GMLC) 225) and/or allow the external client 230 to receive location information regarding the UE 205 (e.g., via the GMLC 225). The external client 230 of FIG. 2 may correspond to external client 180 of FIG. 1, as implemented in or communicatively coupled with a 5G NR network.

The UE 205 may include a single entity or may include multiple entities, such as in a personal area network where a user may employ audio, video and/or data I/O devices, and/or body sensors and a separate wireline or wireless modem. An estimate of a location of the UE 205 may be referred to as a location, location estimate, location fix, fix, position, position estimate, or position fix, and may be geodetic, thus providing location coordinates for the UE 205 (e.g., latitude and longitude), which may or may not include an altitude component (e.g., height above sea level, height above or depth below ground level, floor level or basement level). Alternatively, a location of the UE 205 may be expressed as a civic location (e.g., as a postal address or the designation of some point or small area in a building such as a particular room or floor). A location of the UE 205 may also be expressed as an area or volume (defined either geodetically or in civic form) within which the UE 205 is expected to be located with some probability or confidence level (e.g., 67%, 95%, etc.). A location of the UE 205 may further be a relative location comprising, for example, a distance and direction or relative X, Y (and Z) coordinates defined relative to some origin at a known location which may be defined geodetically, in civic terms, or by reference to a point, area, or volume indicated on a map, floor plan or building plan. In the description contained herein, the use of the term location may comprise any of these variants unless indicated otherwise. When computing the location of a UE, it is common to solve for local X, Y, and possibly Z coordinates and then, if needed, convert the local coordinates into absolute ones (e.g. for latitude, longitude and altitude above or below mean sea level).

Base stations in the NG-RAN 235 shown in FIG. 2 may correspond to base stations 120 in FIG. 1 and may include gNBs 210. Pairs of gNBs 210 in NG-RAN 235 may be connected to one another (e.g., directly as shown in FIG. 2 or indirectly via other gNBs 210). The communication interface between base stations (gNBs 210 and/or ng-eNB 214) may be referred to as an Xn interface 237. Access to the 5G network is provided to UE 205 via wireless communication between the UE 205 and one or more of the gNBs 210, which may provide wireless communications access to the 5G CN 240 on behalf of the UE 205 using 5G NR. The wireless interface between base stations (gNBs 210 and/or ng-eNB 214) and the UE 205 may be referred to as a Uu interface 239. 5G NR radio access may also be referred to as NR radio access or as 5G radio access. In FIG. 2, the serving gNB for UE 205 is assumed to be gNB 210-1, although other gNBs (e.g. gNB 210-2) may act as a serving gNB if UE 205 moves to another location or may act as a secondary gNB to provide additional throughput and bandwidth to UE 205.

Base stations in the NG-RAN 235 shown in FIG. 2 may also or instead include a next generation evolved Node B, also referred to as an ng-eNB, 214. Ng-eNB 214 may be connected to one or more gNBs 210 in NG-RAN 235—e.g. directly or indirectly via other gNBs 210 and/or other ng-eNBs. An ng-eNB 214 may provide LTE wireless access and/or evolved LTE (eLTE) wireless access to UE 205. Some gNBs 210 (e.g. gNB 210-2) and/or ng-eNB 214 in FIG. 2 may be configured to function as positioning-only beacons which may transmit signals (e.g., Positioning Reference Signal (PRS)) and/or may broadcast assistance data to assist positioning of UE 205 but may not receive signals from UE 205 or from other UEs. Some gNBs 210 (e.g., gNB 210-2 and/or another gNB not shown) and/or ng-eNB 214 may be configured to function as detecting-only nodes may scan for signals containing, e.g., PRS data, assistance data, or other location data. Such detecting-only nodes may not transmit signals or data to UEs but may transmit signals or data (relating to, e.g., PRS, assistance data, or other location data) to other network entities (e.g., one or more components of 5G CN 240, external client 230, or a controller) which may receive and store or use the data for positioning of at least UE 205. It is noted that while only one ng-eNB 214 is shown in FIG. 2, some embodiments may include multiple ng-eNBs 214. Base stations (e.g., gNBs 210 and/or ng-eNB 214) may communicate directly with one another via an Xn communication interface. Additionally or alternatively, base stations may communicate directly or indirectly with other components of the 5G NR network 200, such as the LMF 220 and AMF 215.

5G NR network 200 may also include one or more WLANs 216 which may connect to a Non-3GPP InterWorking Function (N3IWF) 250 in the 5G CN 240 (e.g., in the case of an untrusted WLAN 216). For example, the WLAN 216 may support IEEE 802.11 Wi-Fi access for UE 205 and may comprise one or more Wi-Fi APs (e.g., APs 130 of FIG. 1). Here, the N3IWF 250 may connect to other elements in the 5G CN 240 such as AMF 215. In some embodiments, WLAN 216 may support another RAT such as Bluetooth. The N3IWF 250 may provide support for secure access by UE 205 to other elements in 5G CN 240 and/or may support interworking of one or more protocols used by WLAN 216 and UE 205 to one or more protocols used by other elements of 5G CN 240 such as AMF 215. For example, N3IWF 250 may support IPSec tunnel establishment with UE 205, termination of IKEv2/IPSec protocols with UE 205, termination of N2 and N3 interfaces to 5G CN 240 for control plane and user plane, respectively, relaying of uplink (UL) and downlink (DL) control plane Non-Access Stratum (NAS) signaling between UE 205 and AMF 215 across an N1 interface. In some other embodiments, WLAN 216 may connect directly to elements in 5G CN 240 (e.g. AMF 215 as shown by the dashed line in FIG. 2) and not via N3IWF 250. For example, direct connection of WLAN 216 to 5GCN 240 may occur if WLAN 216 is a trusted WLAN for 5GCN 240 and may be enabled using a Trusted WLAN Interworking Function (TWIF) (not shown in FIG. 2) which may be an element inside WLAN 216. It is noted that while only one WLAN 216 is shown in FIG. 2, some embodiments may include multiple WLANs 216.

Access nodes may comprise any of a variety of network entities enabling communication between the UE 205 and the AMF 215. As noted, this can include gNBs 210, ng-eNB 214, WLAN 216, and/or other types of cellular base stations. However, access nodes providing the functionality described herein may additionally or alternatively include entities enabling communications to any of a variety of RATs not illustrated in FIG. 2, which may include non-cellular technologies. Thus, the term “access node,” as used in the embodiments described herein below, may include but is not necessarily limited to a gNB 210, ng-eNB 214 or WLAN 216.

In some embodiments, an access node, such as a gNB 210, ng-eNB 214, and/or WLAN 216 (alone or in combination with other components of the 5G NR network 200), may be configured to, in response to receiving a request for location information from the LMF 220, obtain location measurements of uplink (UL) signals received from the UE 205) and/or obtain downlink (DL) location measurements from the UE 205 that were obtained by UE 205 for DL signals received by UE 205 from one or more access nodes. As noted, while FIG. 2 depicts access nodes (gNB 210, ng-eNB 214, and WLAN 216) configured to communicate according to 5G NR, LTE, and Wi-Fi communication protocols, respectively, access nodes configured to communicate according to other communication protocols may be used, such as, for example, a Node B using a Wideband Code Division Multiple Access (WCDMA) protocol for a Universal Mobile Telecommunications Service (UMTS) Terrestrial Radio Access Network (UTRAN), an eNB using an LTE protocol for an Evolved UTRAN (E-UTRAN), or a Bluetooth® beacon using a Bluetooth protocol for a WLAN. For example, in a 4G Evolved Packet System (EPS) providing LTE wireless access to UE 205, a RAN may comprise an E-UTRAN, which may comprise base stations comprising eNBs supporting LTE wireless access. A core network for EPS may comprise an Evolved Packet Core (EPC). An EPS may then comprise an E-UTRAN plus an EPC, where the E-UTRAN corresponds to NG-RAN 235 and the EPC corresponds to 5GCN 240 in FIG. 2. The methods and techniques described herein for obtaining a civic location for UE 205 may be applicable to such other networks.

The gNBs 210 and ng-eNB 214 can communicate with an AMF 215, which, for positioning functionality, communicates with an LMF 220. The AMF 215 may support mobility of the UE 205, including cell change and handover of UE 205 from an access node (e.g., gNB 210, ng-eNB 214, or WLAN 216) of a first RAT to an access node of a second RAT. The AMF 215 may also participate in supporting a signaling connection to the UE 205 and possibly data and voice bearers for the UE 205. The LMF 220 may support positioning of the UE 205 using a CP location solution when UE 205 accesses the NG-RAN 235 or WLAN 216 and may support position procedures and methods, including UE assisted/UE based and/or network based procedures/methods, such as Assisted GNSS (A-GNSS), Observed Time Difference Of Arrival (OTDOA) (which may be referred to in NR as Time Difference Of Arrival (TDOA)), Frequency Difference Of Arrival (FDOA), Real Time Kinematic (RTK), Precise Point Positioning (PPP), Differential GNSS (DGNSS), Enhanced Cell ID (ECID), angle of arrival (AoA), angle of departure (AoD), WLAN positioning, round trip signal propagation delay (RTT), multi-cell RTT, and/or other positioning procedures and methods. The LMF 220 may also process location service requests for the UE 205, e.g., received from the AMF 215 or from the GMLC 225. The LMF 220 may be connected to AMF 215 and/or to GMLC 225. In some embodiments, a network such as 5GCN 240 may additionally or alternatively implement other types of location-support modules, such as an Evolved Serving Mobile Location Center (E-SMLC) or a SUPL Location Platform (SLP). It is noted that in some embodiments, at least part of the positioning functionality (including determination of a UE 205's location) may be performed at the UE 205 (e.g., by measuring downlink PRS (DL-PRS) signals transmitted by wireless nodes such as gNBs 210, ng-eNB 214 and/or WLAN 216, and/or using assistance data provided to the UE 205, e.g., by LMF 220).

The Gateway Mobile Location Center (GMLC) 225 may support a location request for the UE 205 received from an external client 230 and may forward such a location request to the AMF 215 for forwarding by the AMF 215 to the LMF 220. A location response from the LMF 220 (e.g., containing a location estimate for the UE 205) may be similarly returned to the GMLC 225 either directly or via the AMF 215, and the GMLC 225 may then return the location response (e.g., containing the location estimate) to the external client 230.

A Network Exposure Function (NEF) 245 may be included in 5GCN 240. The NEF 245 may support secure exposure of capabilities and events concerning 5GCN 240 and UE 205 to the external client 230, which may then be referred to as an Access Function (AF) and may enable secure provision of information from external client 230 to 5GCN 240. NEF 245 may be connected to AMF 215 and/or to GMLC 225 for the purposes of obtaining a location (e.g. a civic location) of UE 205 and providing the location to external client 230.

As further illustrated in FIG. 2, the LMF 220 may communicate with the gNBs 210 and/or with the ng-eNB 214 using an NR Positioning Protocol annex (NRPPa) as defined in 3GPP Technical Specification (TS) 38.455. NRPPa messages may be transferred between a gNB 210 and the LMF 220, and/or between an ng-eNB 214 and the LMF 220, via the AMF 215. As further illustrated in FIG. 2, LMF 220 and UE 205 may communicate using an LTE Positioning Protocol (LPP) as defined in 3GPP TS 37.355. Here, LPP messages may be transferred between the UE 205 and the LMF 220 via the AMF 215 and a serving gNB 210-1 or serving ng-eNB 214 for UE 205. For example, LPP messages may be transferred between the LMF 220 and the AMF 215 using messages for service-based operations (e.g., based on the Hypertext Transfer Protocol (HTTP)) and may be transferred between the AMF 215 and the UE 205 using a 5G NAS protocol. The LPP protocol may be used to support positioning of UE 205 using UE assisted and/or UE based position methods such as A-GNSS, RTK, TDOA, multi-cell RTT, AoD, and/or ECID. The NRPPa protocol may be used to support positioning of UE 205 using network based position methods such as ECID, AoA, uplink TDOA (UL-TDOA) and/or may be used by LMF 220 to obtain location related information from gNBs 210 and/or ng-eNB 214, such as parameters defining DL-PRS transmission from gNBs 210 and/or ng-eNB 214.

In the case of UE 205 access to WLAN 216, LMF 220 may use NRPPa and/or LPP to obtain a location of UE 205 in a similar manner to that just described for UE 205 access to a gNB 210 or ng-eNB 214. Thus, NRPPa messages may be transferred between a WLAN 216 and the LMF 220, via the AMF 215 and N3IWF 250 to support network-based positioning of UE 205 and/or transfer of other location information from WLAN 216 to LMF 220. Alternatively, NRPPa messages may be transferred between N3IWF 250 and the LMF 220, via the AMF 215, to support network-based positioning of UE 205 based on location related information and/or location measurements known to or accessible to N3IWF 250 and transferred from N3IWF 250 to LMF 220 using NRPPa. Similarly, LPP and/or LPP messages may be transferred between the UE 205 and the LMF 220 via the AMF 215, N3IWF 250, and serving WLAN 216 for UE 205 to support UE assisted or UE based positioning of UE 205 by LMF 220.

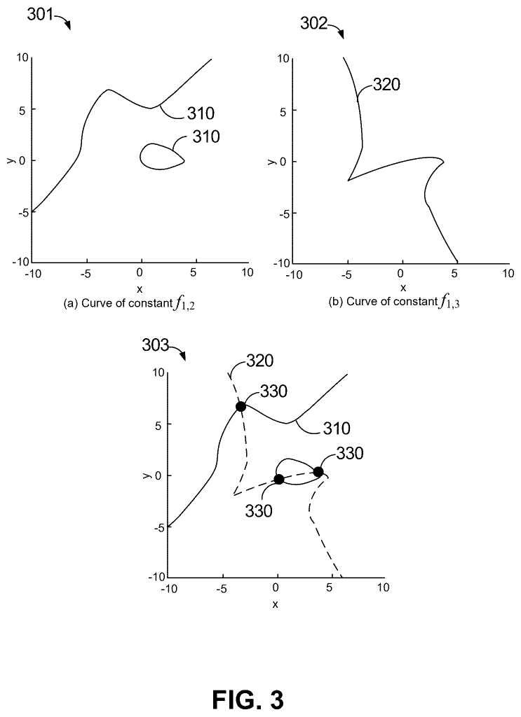

As noted above, TDOA-based and FDOA-based measurements may be used for sensing target(s) in systems such as communication/positioning/sensing system 100 shown in FIGS. 1 and/or 5G NR network 200 shown in FIG. 2. FIG. 3 is a diagram showing geometry of an example of how existing FDOA-based sensing may be performed and associated terminology. Different from TDOA, the FDOA measurements are caused by the Doppler shift of the signal due to disparities between the receiver and emitter velocities. With the assumption that the emitter is fixed in position, the Doppler shift of the signal at receiver i, scaled by the center frequency of the transmitted signal (f₀) divided by speed of propagation (c) is:

$${d}_{i} = \frac{{f}_{0}}{c} ( {v}_{i} \cdot \frac{x - {x}_{i}}{‖ x - {x}_{i} ‖} )$$

where dᵢ is proportional to the frequency shift of the signals at receiver i, x is the location of the emitter, and xᵢ is the location of the i-th receiver. The FDOA between receivers i and 1 is proportional to:

$${f}_{1 , i} = {d}_{i} - {d}_{1} = \frac{{f}_{0}}{c} ( {v}_{i} \cdot \frac{x - {x}_{i}}{‖ x - {x}_{i} ‖} - {v}_{1} \cdot \frac{x - {x}_{1}}{‖ x - {x}_{1} ‖} )$$

where f₀ and c are the constant and known by the system, f_{1,i} is the measured frequency difference. x, x₁ and xᵢ are the node locations.

Based on different f_{1,i} associated to the multiple nodes (e.g., different receivers), e.g., f_{1,2}, f_{1,3}, the positioning and Doppler information can be derived. For example, as shown in FIG. 3, curves 310 and 320 in plots 301 and 302 show constant FDOAs for fixed set of parameters (e.g., f_{1,2}, f_{1,3}) respectively. X and y axes in plots 301, 302, and 303 are in units of meters. As noted above, curves 310 and 320 can identify the location of the emitter x, e.g., any intersection of the curves 310 and 320 (e.g., intersections 330 shown in plot 303) is a potential emitter location.

In practice, there are oscillator errors at both the emitter and the receiver. For example, in multi-static setting, both the emitter and receiver would involve two separate oscillator errors. In the mono-static setting, the oscillator errors at both the emitter and receiver may also be different. Especially, when using UEs as receivers, the oscillators of which are often not temperature controlled, sizable error in the generated frequency which varies throughout the day depending on the temperature may be introduced. As a result, the frequency offset measured by the UE includes not only Doppler shift but also the sizable oscillator errors. In wireless communications, the UE modem doesn't attempt to distinguish the Doppler shift from the oscillator errors, and the sum of both offsets are estimated and compensated by employing frequency tracking loop (FTL), which leads to satisfactory modem performance. But, for sensing purposes (e.g., accurately determining the motion of the target), it is important to remove the estimation bias caused by the UE oscillator error from the frequency offset estimate in order to obtain accurate Doppler shift estimates.

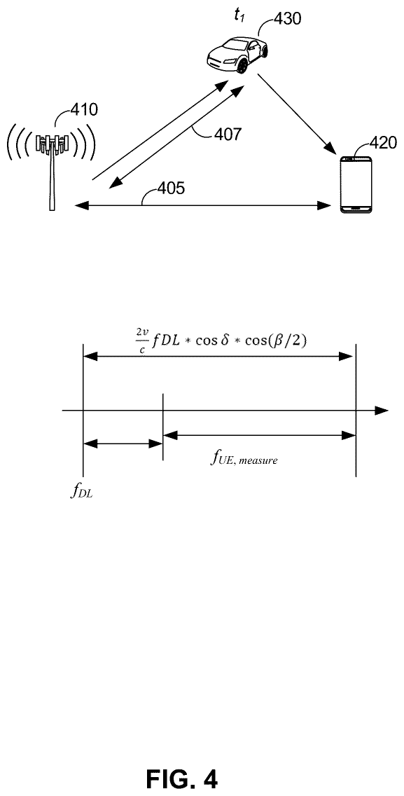

FIG. 4 is a diagram showing an example of oscillator errors in a frequency offset measurement of a FDOA-based sensing and associated terminology. As shown in FIG. 4, in a bi-static setting, a transmitter 410 (e.g., base station 120 in FIG. 1 and/or gNBs 210 in FIG. 2) and a receiver 420 (e.g., UE 105 in FIGS. 1 and 2) jointly configured to detect a target 430 (e.g., mobile device 145 in FIG. 1) are separated by a distance 405 comparable to the expected target distance 407 (e.g., the distance from transmitter 410 and/or receiver 420 to target 430). The normalized frequency offset measured by UE can be determined according to:

$$\frac{{f}_{UE , measure}}{{f}_{D L}} = 2 \frac{v}{c} cos δ \cdot cos ( \frac{β}{2} ) - \frac{{f}_{o f f}}{{f}_{o}} , and$$

$${f}_{o f f} = {f}_{off , gNB , T x} + {f}_{off , UE , Rx}$$

where f_{DL} denotes the downlink (DL) carrier frequency, v denotes velocity of the target, c denotes speed of light, f_{UE,measure} denotes frequency offset measured at UE,

$$\frac{{f}_{o f f}}{{f}_{o}} {f}_{D L}$$

denotes the oscillator errors in DL direction (Rx), f_{off,gNB,Tx} denotes the oscillator error from transmitter 310, and f_{off,UE,Rx} denotes the oscillator error from receiver 320. The target velocity component corresponding to the bistatic doppler shifts=v cos δ·cos(β/2). The uplink (UL) procedure is similar to the above. As shown in FIG. 4, the estimated Doppler shift includes the oscillator errors which is associated to the hardware and temperature, and which is sometimes hard to accurately estimate. Accordingly, FDOA-based sensing schemes that remove/mitigate the impact of oscillator errors would be advantageous.

The technical solutions disclosed herein provide improved FDOA-based sensing that can remove the estimation bias caused by the UE oscillator error from the frequency offset estimates. For example, the improved FDOA-based sensing may take multiple measurements with a same device from a predetermined time window within which the oscillator error for the same device is constant (e.g., any oscillator errors caused by the environmental change, e.g., temperature changes, will be negligible). Accordingly, the accuracy of the Doppler shift estimates can be improved.

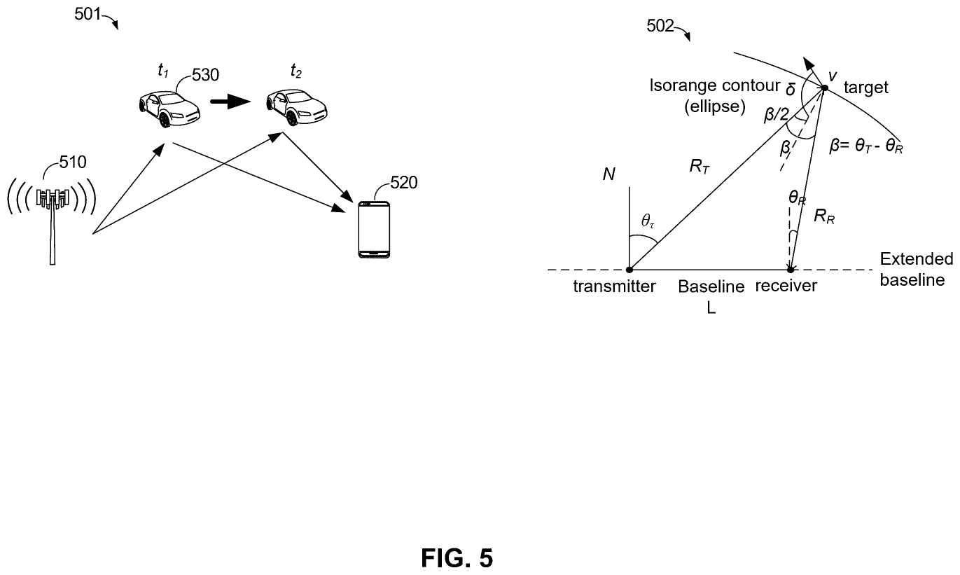

FIG. 5 is a diagram showing an example of how an improved FDOA-based sensing for sensing a target may be performed and associated geometry, according to some embodiments. As shown in diagram 501, a transmitter 510 (e.g., base station 120 in FIG. 1 and/or gNBs 210 in FIG. 2) and a receiver 520 (e.g., UE 105 in FIGS. 1 and 2) jointly configured to detect a target 530 (e.g., mobile device 145 in FIG. 1). In some embodiments, target 530 may correspond to a vehicle, a pedestrian, or any suitable target having relative movement with regard to transmitter 510 and/or receiver 520.

Different from existing FDOA-based sensing scheme where signals received by different receivers at a same timestamp (t₁) are used to determine the FDOA measurements as illustrated above (e.g., as described with FIG. 3), the improved FDOA-based sensing disclosed herein leverages measurements of signals received at different timestamps (e.g., measured frequency offsets

$$\frac{{f}_{UE , measure , t 1}}{{f}_{D L}} and \frac{{f}_{UE , measure , t 2}}{{f}_{D L}}$$

determined at t₁ and t₂ respectively) to determine the FDOA measurements which reduces/mitigates oscillator errors. In some embodiments, the different timestamps may be selected from a predetermined time window T. It is understood that the number of timestamps are not limited to two. Increasing the number of measurements determined at different timestamps (e.g., determine more FDOA measurements based on signals transmitted at more different timestamps selected from time window T) may increase the accuracy of the sensing result.

As discussed, the oscillator error may be relatively stable within a short time window for a specific device (e.g., transmitter 510 and/or receiver 520) (e.g., relatively stable means any errors due to stability will be negligible). Accordingly, within a properly defined predetermined window T, it is assumed that there will be negligible changes for the oscillator errors at timestamps t₁ and t₂ within the window T. In some embodiments, the duration of the window T may be determined according to the type of the target (e.g., the speed of the target), the environment (e.g., the temperature change), and/or the type of sensing devices used (e.g., the type of transmitter 510 and/or receiver 520).

According to the geometry of the improved FDOA-based sensing shown in plot 502, the FDOA of Δf_{1,2} can be determined according to:

$$Δ {f}_{1 , 2} = \frac{{f}_{UE , measuref 1}}{{f}_{D L}} - \frac{{f}_{UE , measure , f 2}}{{f}_{D L}} = ( 2 \frac{v 1}{c} cos δ1 \cdot cos ( \frac{β 1}{2} ) - \frac{{f}_{o f f}}{{f}_{o}} ) - ( 2 \frac{v 2}{c} cos δ2 \cdot cos ( \frac{β 2}{2} ) - \frac{{f}_{o f f}}{{f}_{o}} ) = 2 \frac{v 1}{c} cos δ1 \cdot cos ( \frac{β 1}{2} ) - 2 \frac{v 2}{c} cos δ2 \cdot cos ( \frac{β 2}{2} )$$

where

$$\frac{{f}_{o f f}}{{f}_{o}}$$

is the oscillator error and can be cancelled, β denotes the bistatic angle (the angle at the target subtended by the transmitter and receiver), v denotes the target velocity, β denotes the angle between β/2 and the target velocity, and v1, δ1, β1, v2, δ2, and β2 correspond to v, δ, and β shown in plot 502 at different timestamps t₁ and t₂. As a result, after taking multiple FDOA measurements based on signals received at different timestamps selected from the time window T (e.g., Δf_{1,2}, Δf_{1,3}, . . . ), the oscillator errors in the position and/or the Doppler information determined based on the FDOA measurements can be removed. It is understood that the bi-static setting disclosed herein is for illustrative purpose only. For a different setting, e.g., monostatic sensing or others, other suitable procedures may be used.

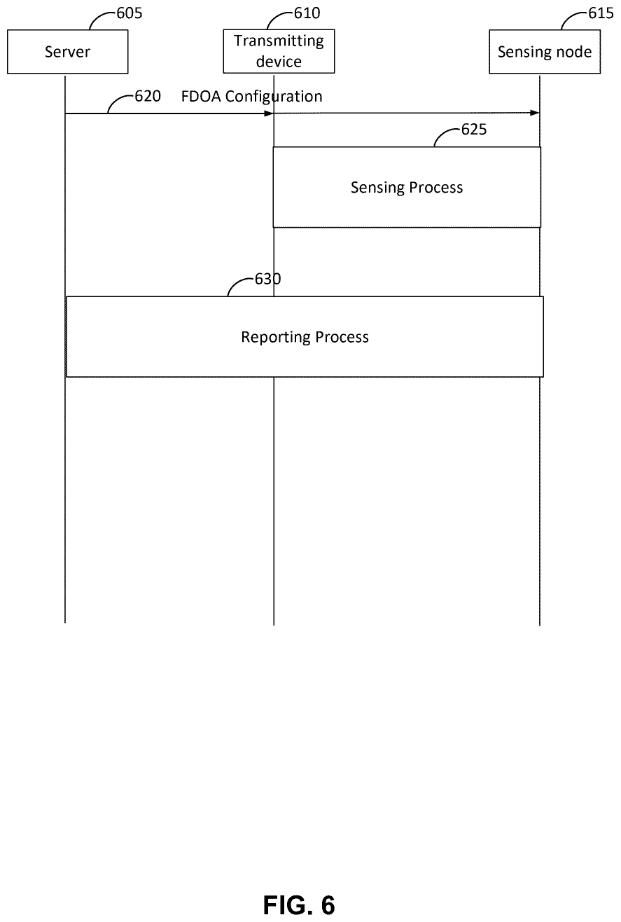

FIG. 6 is a flow diagram illustrating how the improved FDOA-based sensing for sensing a target may be performed in a bi-static setting, according to some embodiments. In some embodiments, the improved FDOA-based sensing for sensing the target may be performed between a server 605, a transmitting device 610, and a sensing node 615. In some embodiments, server 605 may correspond to location server 160 in FIG. 1 (e.g., including an LMF), a proprietary server, a packet controller (e.g., including a session management function (SMF)) or any other suitable servers. Transmitting device 610 may correspond to transmitter 510 in FIG. 5, base station 120 of FIG. 1, and/or gNB 210 of FIG. 2. Sensing node 615 may correspond to receiver 520 in FIG. 5 and/or UE 105 in FIGS. 1 and 2. In some embodiments, the target to be sensed may correspond to mobile device 145 in FIG. 1 or any target suitable for being sensed by FDOA-based sensing.

Starting at arrow 620, server 605 may send an improved FDOA-based sensing configuration to transmitting device 610 and sensing node 615, configuring transmitting device 610 and sensing node 615 to perform the improved FDOA-based sensing for sensing the target. As will be discussed in detail below, the transmission of the RF signals for sensing the target may be performed in accordance with the improved FDOA-based sensing configuration.

At block 625, an improved FDOA-based sensing may be performed between transmitting device 610 and sensing node 615 according to the improved FDOA-based sensing configuration. For example, in some embodiments, transmitting device 610 may transmit a plurality of RF signals at different time points, e.g., transmit a first RF signal at a first time point corresponding to timestamp t₁, a second RF signal at a second time point corresponding to timestamp t₂, a third RF signal at a third time point corresponding to timestamp t₃, etc. As discussed above, the plurality of time points may be selected from a predetermined time window T. The plurality of RF signals may be reflected by the target and received by sensing node 615. Sensing node 615 may determine the frequency offsets f_{UE,measures} of the reflection of the plurality of RF signals, reflected by the target and received by sensing node 615.

At block 630, a reporting process may be performed according to the improved FDOA-based sensing configuration. In some embodiments, sensing node 615 may transmit the frequency offsets to transmitting device 610 and/or server 605 and transmitting device 610 and/or server 605 may determine the FDOA measurements based on the frequency offsets as disclosed above. Additionally or alternatively, sensing node 615 may determine the FDOA measurements based on the frequency offsets as disclosed above and transmit the FDOA measurements to transmitting device 610 and/or server 605. Transmitting device 610 and/or server 605 receiving the FDOA measurements may determine the Doppler information and/or position of the target based on the FDOA measurements. In some embodiments, the determination (e.g., the position and/or Doppler information of the target) may be shared with/transmitted to transmitting device 610 and/or server 605.

During the reporting process, if sensing node 615 is static as with speed and location, the speed and location of sensing node 615 may not be reported repeatedly along with the estimated frequency offset or the frequency difference. For example, a report for measurements determined based on a RF signal transmitted at timestamp t₁ may include the corresponding frequency offset

$$( e . g . , \{ \frac{{f}_{UE , measure , t 1}}{{f}_{D L}} \} ) .$$

For example, a format of the report may be

$$\{ \frac{{f}_{UE , measure , t 1}}{{f}_{D L}} , \frac{{f}_{UE , measure , t 2}}{{f}_{D L}} , \frac{{f}_{UE , measure , t 3}}{{f}_{D L}} , … , Location \} .$$

Alternatively or additionally, if sensing node 615 is moving, the speed and location of sensing node 615 may also be reported along with the frequency offsets. For example, report for measurements determined based on a RF signal transmitted at timestamp t₁ may include the corresponding frequency offset, the speed, and the location of sensing node 615

$$( e . g . , \{ \frac{{f}_{UE , measure , t 1}}{{f}_{D L}} , {Location\_t}_{1} , {speed\_t}_{1} \} )$$

For example, a format of the report may be

$$\{ [ \frac{{f}_{UE , measure , t 1}}{{f}_{DL}} , {Location\_t}_{1} , {speed\_t}_{1} ] , \\ [ \frac{{f}_{UE , measure , t 2}}{{f}_{DL}} , {Location\_t}_{2} , {speed\_t}_{2} ] , … \} .$$

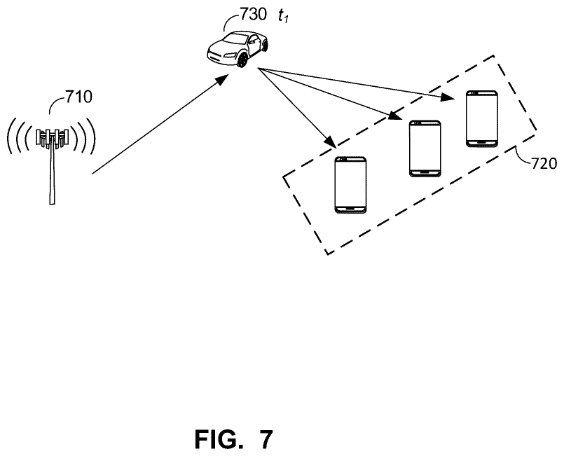

FIG. 7 is a diagram showing an example of how an improved FDOA-based sensing for sensing a target may be performed in a multi-static setting, according to some embodiments. As shown in FIG. 7, a transmitter 710 (e.g., base station 120 in FIG. 1 and/or gNBs 210 in FIG. 2) and a plurality of receivers 720 (e.g., UEs 105 in FIGS. 1 and 2) are jointly configured to detect a target 730 (e.g., mobile device 145 in FIG. 1). In some embodiments, target 730 may correspond to a vehicle, a pedestrian, or any suitable target having relative movement with regard to transmitter 710 and/or plurality of receiver 720.

Different from existing FDOA-based sensing scheme, in some embodiments, the plurality of receivers 720 may be selected as those sharing a same/similar hardware (e.g., are equipped with a same type and/or a same model of oscillator(s)) such that at a same time point, e.g., corresponding to timestamp t₁, the frequency offsets measured based on the signals received by the plurality of receivers 720

$$( e . g . , \frac{{f}_{UE , measure , RX 1}}{{f}_{D L}} , \frac{{f}_{UE , measure , RX 2}}{{f}_{D L}} , \frac{{f}_{UE , measure , RX 3}}{{f}_{D L}} )$$

may suffer from a same or similar oscillator error. So, when determining the FDOA measurements based on those frequency offsets

$$( e . g . , Δ {f}_{1 , 3} = \frac{{f}_{UE , measure , RX 1}}{{f}_{D L}} - \frac{{f}_{UE , measure , RX 3}}{{f}_{D L}} ) ,$$

the oscillator error may be canceled out. Additionally or alternatively, if the plurality of receivers 720 hold different oscillator errors like in existing settings (e.g., equipped with different type and/or model of oscillator(s), and/or located in places with large temperature differences), each receiver 720 may individually perform bi-static sensing as discussed with regard to FIGS. 5 and 6 to remove the oscillator errors.

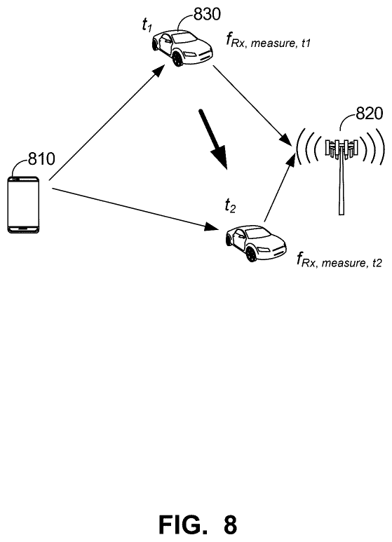

FIG. 8 is a diagram showing an example of how an improved FDOA-based sensing for sensing a transmitting device may be performed, according to some embodiments. As shown in FIG. 5, a transmitting device 810 to be sensed may correspond to mobile device 145 (e.g., attached to a vehicle, a pedestrian, or any suitable target having relative movement with regard to receiver 820). In some embodiments, reflector 830 may be a reconfigurable intelligent surface (RIS), a vehicle, or any suitable object with a known Doppler information (e.g., known location and speed).

Similar to the improved FDOA-based sensing for sensing the target, here the method leverages measurements of signals received by receiver 820 (e.g., transmitted by transmitting device 810, reflected by reflector 830, and received by receiver 820) at different time points (e.g., measured frequency offsets f_{UE,measure,t1} and f_{UE,measure,2} determined at t₁ and t₂ respectively) to determine the FDOA measurements. In some embodiments, the different time points may be selected from a predetermined time window T. Increasing the number of measurements determined at different time points (e.g., determine more FDOA measurements based on signals transmitted at more different time points selected from time window T) may increase the accuracy of the sensing result. As discussed, in some embodiments, the duration of the window T may be determined according to the type of the target (e.g., the speed of the target), the environment (e.g., the temperature changing speed), and/or the type of sensing devices used (e.g., the type of transmitting device 810 and/or receiver 820).

Accordingly, the FDOA measurement of Δf_{t1,t2} can be determined according to:

$$Δ {f}_{t 1 , t 2} = {f}_{R x , measure , t 1} - {f}_{R x , m e a s u re , t 2}$$

In some embodiments, the improved FDOA-based sensing for sensing a transmitting device can also leverage signals received by receiver 820 at a same time point but through different paths (e.g., reflected by different reflectors f_{Rx,measure,path1} and f_{Rx,measure,path2}). The FDOA of Δf_{t1,t2} can be determined according to:

$$Δ {f}_{path , 1 , path 2} = {f}_{R x , m easure , path 1} - {f}_{R x , m easure , path 2}$$

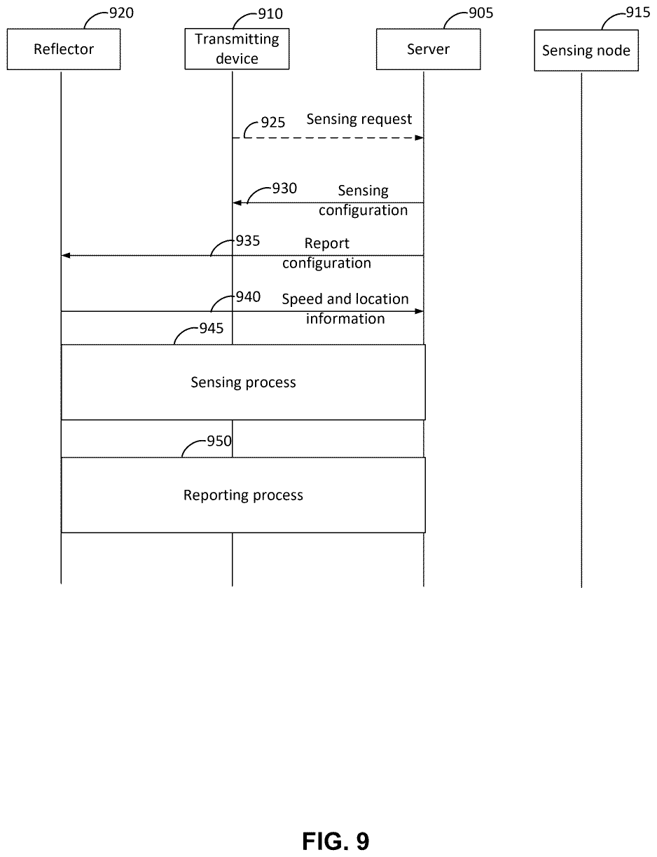

FIG. 9 is a flow diagram illustrating how the improved FDOA-based sensing for sensing a transmitting device may be performed, according to some embodiments. In some embodiments, the improved FDOA-based sensing for sensing the transmitting device may be performed between a server 905, a transmitting device 910, a sensing node 915, and reflectors 920. In some embodiments, server 905 may correspond to location server 160 in FIG. 1 (e.g., including an LMF), a proprietary server, a packet controller (e.g., including a session management function (SMF)) or any other suitable servers. Transmitting device 910 may correspond to transmitting device 810 in FIG. 8, UE 105 in FIGS. 1 and 2, mobile device 145 in FIG. 1 or may correspond to any target suitable for being sensed by FDOA-based sensing. Sensing node 915 may correspond to base station 120 of FIG. 1, and/or gNB 210 of FIG. 2. Reflectors 920 may correspond to reflector 830 in FIG. 8 and may be a RIS, a vehicle, or any suitable object with a known Doppler information (e.g., known location and speed).

In some embodiments, the improved FDOA-based sensing may optionally start at arrow 925 where transmitting device 910 may transmit a sensing request to server 905.

At arrow 930, server 905 may send an improved FDOA-based sensing configuration to transmitting device 910 In some embodiments, the improved FDOA-based sensing configuration configures transmitting device 910 to the RF signals for sensing transmitting device 910.

At arrow 935, server 905 may send a report configuration to reflector 920 scheduling reflector 920 to report the speed and location information of reflector 920 to server 905.

At arrow 940, reflector 920 may report back the speed and location information to server 905 according to the configuration.

At block 945, an improved FDOA-based sensing may be performed between transmitting device 910, sensing node 915, and reflector 920 according to the improved FDOA-based sensing configuration. For example, in some embodiments, transmitting device 910 may transmit a plurality of RF signals at different time points, e.g., transmit a first RF signal at a first time point corresponding to timestamp t₁, a second RF signal at a second time point corresponding to timestamp t₂, a third RF signal at a third time point corresponding to timestamp t₃, etc. As discussed above, the plurality of timestamps may be selected from a predetermined time window T. The plurality of RF signals may be reflected by reflectors 920 and received by sensing node 915. Sensing node 915 may determine the frequency offsets f_{UE,measures} of the reflection of the plurality of RF signals, reflected by reflectors 920 and received by sensing node 915.

At block 950, a reporting process may be performed according to the improved FDOA-based sensing configuration. In some embodiments, sensing node 915 may transmit the frequency offsets to server 905 and server 905 may determine the FDOA measurements based on the frequency offsets as disclosed above. Additionally or alternatively, sensing node 915 may determine the FDOA measurements based on the frequency offsets as disclosed above and transmit the FDOA measurements to server 905. In some embodiments, sensing node 915 and/or server 905 may determine the location and the Doppler information of the target (e.g., transmitting device 910) based on the FDOA measurements. In some embodiments, the determination (e.g., the location and the Doppler information of the target) may be shared with/transmitted to sensing node 915 and/or server 905.

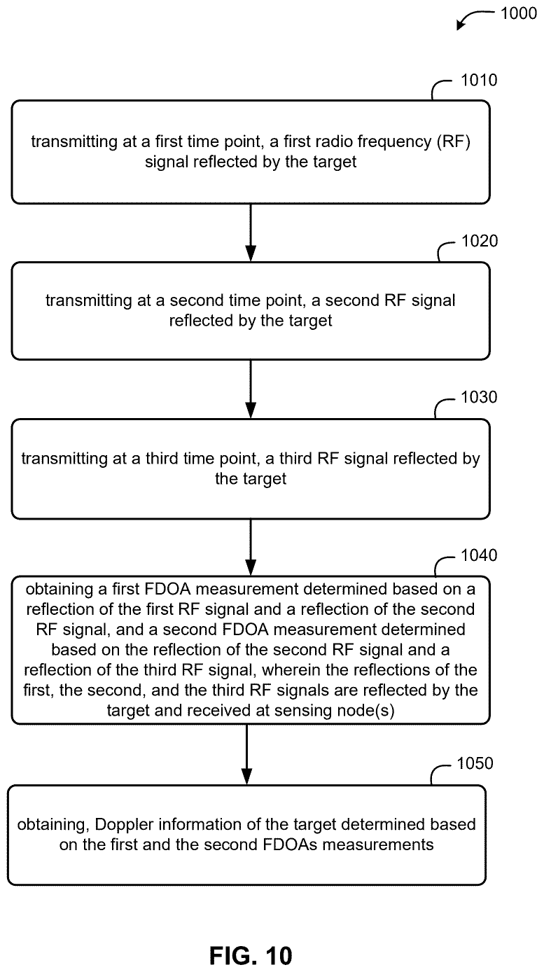

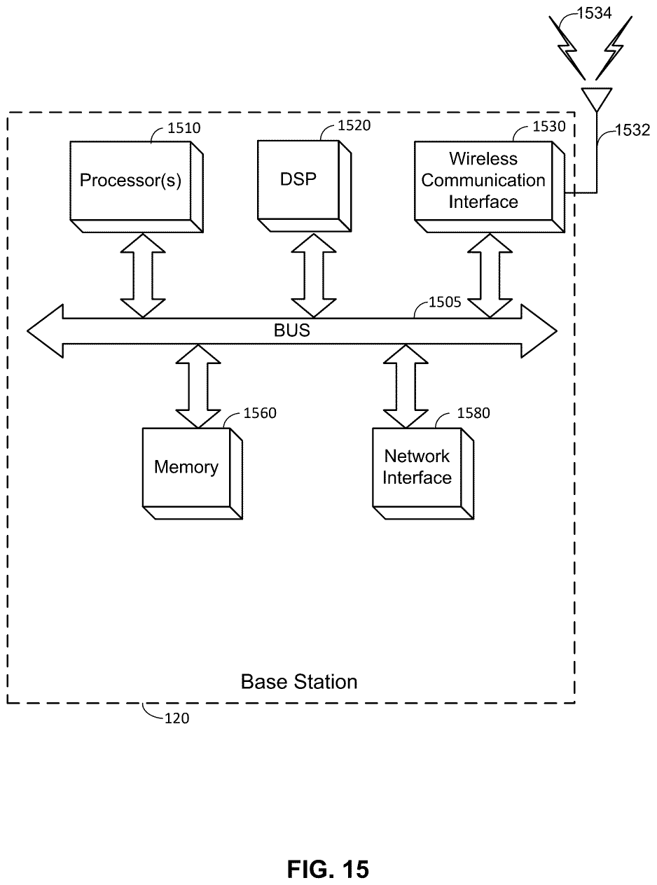

FIG. 10 is a flow diagram of a method 1000 of an improved FDOA-based sensing for sensing a target performed by a transmitting device, according to an embodiment. In some embodiments, the transmitting device may correspond to transmitter 510 in FIG. 5 and transmitting device 610 in FIG. 6. Means for performing the functionality illustrated in one or more of the blocks shown in FIG. 10 may be performed by hardware and/or software components of a base station. Example components of base station 120 are illustrated in FIG. 15, which is described in more detail below.

At block 1010, the functionality comprises transmitting at a first time point corresponding to timestamp t₁, a first radio frequency (RF) signal reflected by the target. Means for performing functionality at block 1010 may comprise a bus 1505, processor(s) 1510, memory 1560, wireless communication interface 1530, and/or other components of base station 120, as illustrated in FIG. 15.

At block 1020, the functionality comprises transmitting at a second time point corresponding to timestamp t₂, a second RF signal reflected by the target. Means for performing functionality at block 1020 may comprise a bus 1505, processor(s) 1510, memory 1560, wireless communication interface 1530, and/or other components of base station 120, as illustrated in FIG. 15.

At block 1030, the functionality comprises transmitting at a third time point corresponding to timestamp t₃, a third RF signal reflected by the target. Means for performing functionality at block 1030 may comprise a bus 1505, processor(s) 1510, memory 1560, wireless communication interface 1530, and/or other components of base station 120, as illustrated in FIG. 15.

As noted above, in some embodiments, the different time points (e.g., corresponding to timestamps t₁, t₂, and t₃ respectively) may be selected from a predetermined time window T. In some embodiments, the reflections of the plurality of RF signals may be received by sensing node(s) (e.g., sensing node 615 in FIG. 6) and the sensing node(s) may determine the frequency offsets f_{UE,measures} of the reflections.

At block 1040, the functionality comprises obtaining a first FDOA measurement determined based on a reflection of the first RF signal and a reflection of the second RF signal, and a second FDOA measurement determined based on the reflection of the second RF signal and a reflection of the third RF signal, wherein the reflections of the first, the second, and the third RF signals are reflected by the target and received at the sensing node(s). Means for performing functionality at block 1040 may comprise a bus 1505, processor(s) 1510, memory 1560, wireless communication interface 1530, and/or other components of base station 120, as illustrated in FIG. 15.

At block 1050, the functionality comprises obtaining, Doppler information of the target determined based on the first and the second FDOAs measurements. For example, the Doppler information may be determined based on the first and the second FDOA measurements. As disclosed above, a location and a speed of the target may be determined based on the Doppler information of the target. Means for performing functionality at block 1010 may comprise a bus 1505, processor(s) 1510, memory 1560, wireless communication interface 1530, and/or other components of base station 120, as illustrated in FIG. 15.

In some embodiments, prior to block 1010, method 1000 may also include receiving, from a server, a FDOA-based sensing configuration for positioning the target, wherein transmitting the first, the second, and the third RF signals are in accordance with the FDOA-based sensing configuration. Accordingly, the functionalities at blocks 1040 and 1050 may be performed according to the FDOA-based sensing configuration. For example, the sensing node may transmit the frequency offsets to the transmitting device and/or the server and the transmitting device and/or the server may determine the FDOA measurements based on the frequency offsets as disclosed above. Additionally or alternatively, the sensing node may determine the FDOA measurements based on the frequency offsets as disclosed above and transmit the FDOA measurements to the transmitting device and/or the server. The transmitting device and/or the server receiving the FDOA measurements may determine the Doppler information and/or position of the target based on the FDOA measurements. In some embodiments, the determination (e.g., the position and/or Doppler information of the target) may be shared with/transmitted to the transmitting device and/or the server. For example, method 1000 may also include receiving, from the server, the Doppler information of the target determined based on the first and the second FDOAs.

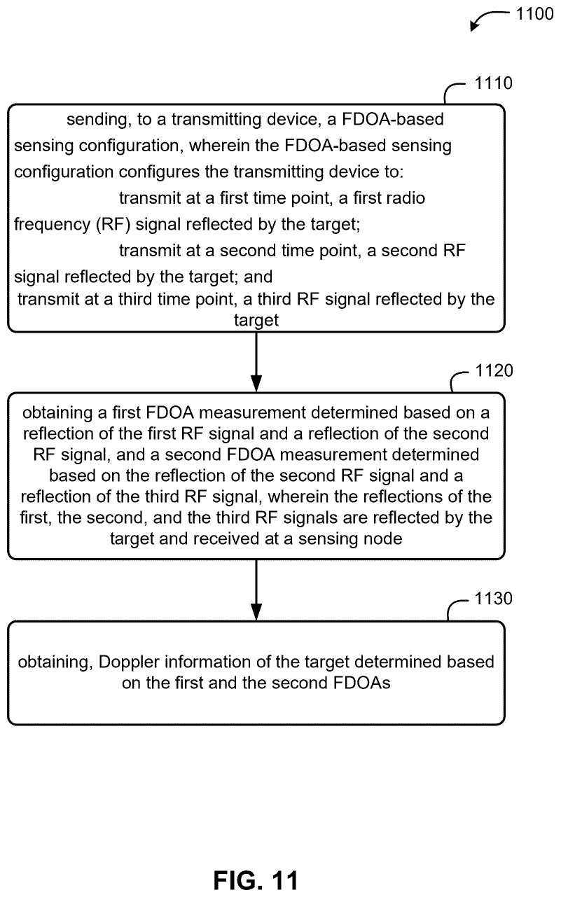

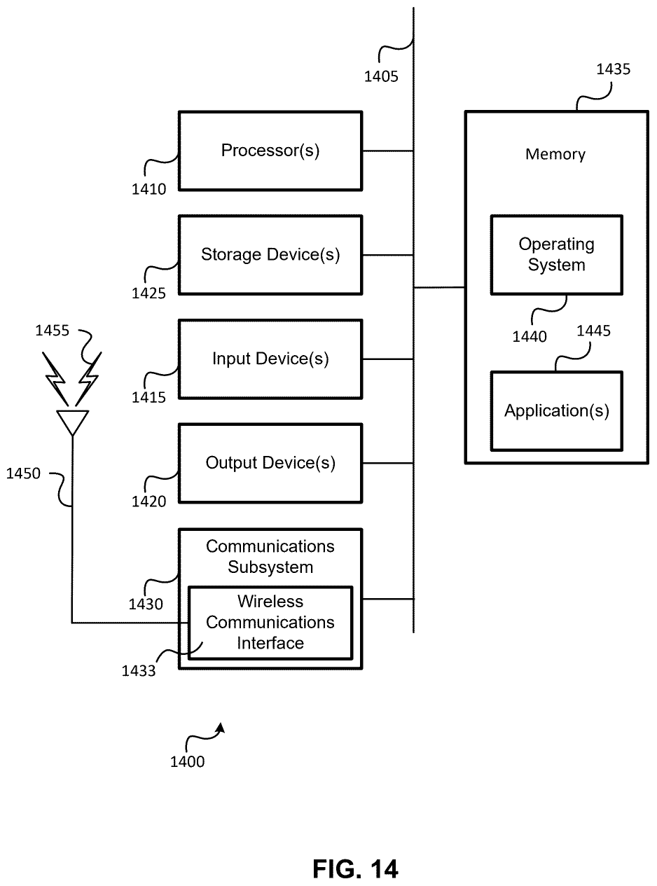

FIG. 11 is a flow diagram of a method 1100 of an improved FDOA-based sensing for sensing a target performed by a server, according to an embodiment. In some embodiments, the server may correspond to server 605 in FIG. 6, location server 160 in FIG. 1 (e.g., including an LMF), a proprietary server, a packet controller (e.g., including a session management function (SMF)), or any other suitable servers. Means for performing the functionality illustrated in one or more of the blocks shown in FIG. 11 may be performed by hardware and/or software components of a computer system. Example components of a computer system are illustrated in FIG. 14, which is described in more detail below.

At block 1110, the functionality comprises sending, to a transmitting device, a FDOA-based sensing configuration, wherein the FDOA-based sensing configuration configures the transmitting device to: transmit at a first time point corresponding to timestamp t₁, a first RF signal reflected by the target; transmit at a second time point corresponding to timestamp t₂, a second RF signal reflected by the target; and transmit at a third time point corresponding to timestamp t₃, a third RF signal reflected by the target. Means for performing functionality at block 1110 may comprise a bus 1405, processor(s) 1410, memory 1435, wireless communication interface 1433, and/or other components of computer system 1400, as illustrated in FIG. 14.

As noted above, in some embodiments, the different timestamps t₁, t₂, and t₃ may be selected from a predetermined time window T. In some embodiments, the reflections of the plurality of RF signals may be received by sensing node(s) (e.g., sensing node 615 in FIG. 6) and the sensing node(s) may determine the frequency offsets f_{UE,measures} of the reflections.

At block 1120, the functionality comprises obtaining a first FDOA measurement determined based on a reflection of the first RF signal and a reflection of the second RF signal, and a second FDOA measurement determined based on the reflection of the second RF signal and a reflection of the third RF signal, wherein the reflections of the first, the second, and the third RF signals are reflected by the target and received at a sensing node. Means for performing functionality at block 1120 may comprise a bus 1405, processor(s) 1410, memory 1435, wireless communication interface 1433, and/or other components of computer system 1400, as illustrated in FIG. 14.

At block 1130, the functionality comprises obtaining, Doppler information of the target determined based on the first and the second FDOAs. Means for performing functionality at block 1130 may comprise a bus 1405, processor(s) 1410, memory 1435, wireless communication interface 1433, and/or other components of computer system 1400, as illustrated in FIG. 14.

In some embodiments, the functionalities at blocks 1120 and 1130 may be performed according to the FDOA-based sensing configuration. For example, the sensing node may transmit the frequency offsets to the transmitting device and/or the server and the transmitting device and/or the server may determine the FDOA measurements based on the frequency offsets as disclosed above. Additionally or alternatively, the sensing node may determine the FDOA measurements based on the frequency offsets as disclosed above and transmit the FDOA measurements to the transmitting device and/or the server. The transmitting device and/or the server receiving the FDOA measurements may determine the Doppler information and/or position of the target based on the FDOA measurements. In some embodiments, the determination (e.g., the position and/or Doppler information of the target) may be shared with/transmitted to the transmitting device and/or the server. For example, method 1100 may also include receiving, from the sensing node, the first and the second FDOA measurements determined based on the reflections of the first RF signal, the second RF signal, and the third RF signal received by the sensing node.

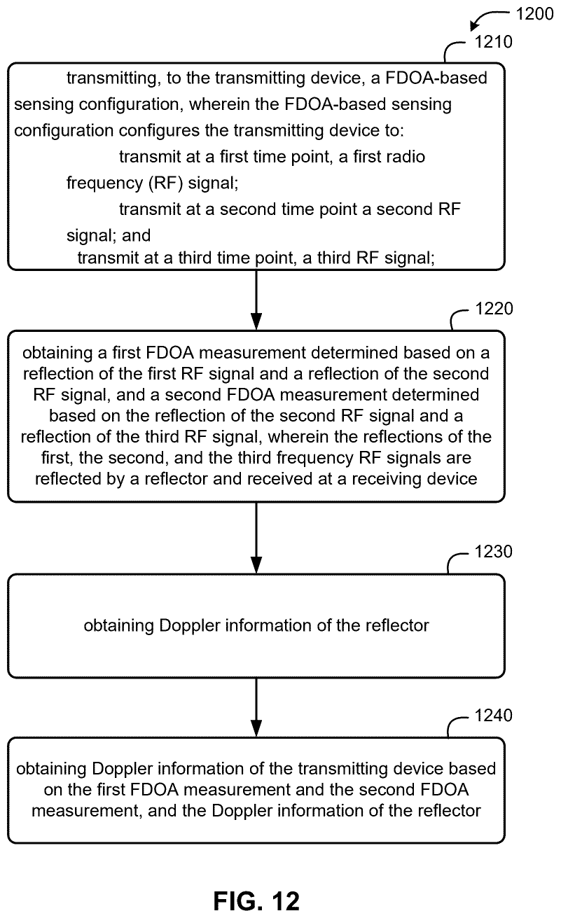

FIG. 12 is a flow diagram of a method 1200 of an improved FDOA-based sensing for sensing a transmitting device performed by a server, according to an embodiment. In some embodiments, the transmitting device may correspond to t server 905 in FIG. 9, location server 160 in FIG. 1 (e.g., including an LMF), a proprietary server, a packet controller (e.g., including a session management function (SMF)) or any other suitable servers. Means for performing the functionality illustrated in one or more of the blocks shown in FIG. 12 may be performed by hardware and/or software components of a computer system. Example components of a computer system are illustrated in FIG. 14, which is described in more detail below.

At block 1210, the functionality comprises transmitting, to the transmitting device, a FDOA-based sensing configuration, wherein the FDOA-based sensing configuration configures the transmitting device to: transmit at a first time point corresponding to timestamp t₁, a RF signal; transmit at a second time point corresponding to timestamp t₂, a second RF signal; and transmit at a third time point corresponding to timestamp t₃, a third RF signal. Means for performing functionality at block 1210 may comprise a bus 1405, processor(s) 1410, memory 1435, wireless communication interface 1433, and/or other components of computer system 1400, as illustrated in FIG. 14.

As discussed above, the plurality of time points t₁, t₂, and t₃ may be selected from a predetermined time window T. The plurality of RF signals may be reflected by the reflector (e.g., reflectors 920 in FIG. 9) and received by the receiver (e.g., sensing node 915 in FIG. 9). The receiver may determine the frequency offsets f_{UE,measures} of the reflections of the plurality of RF signals.

At block 1220, the functionality comprises obtaining a first FDOA measurement determined based on a reflection of the first RF signal and a reflection of the second RF signal, and a second FDOA measurement determined based on the reflection of the second RF signal and a reflection of the third RF signal, wherein the reflections of the first, the second, and the third RF signals are reflected by the reflector and received at the receiving device. Means for performing functionality at block 1220 may comprise a bus 1405, processor(s) 1410, memory 1435, wireless communication interface 1433, and/or other components of computer system 1400, as illustrated in FIG. 14.

At block 1230, the functionality comprises obtaining Doppler information of the reflector. Means for performing functionality at block 1230 may comprise a bus 1405, processor(s) 1410, memory 1435, wireless communication interface 1433, and/or other components of computer system 1400, as illustrated in FIG. 14.

At block 1240, the functionality comprises obtaining Doppler information of the transmitting device based on the first FDOA measurement and the second FDOA measurement, and the Doppler information of the reflector. Means for performing functionality at block 1240 may comprise a bus 1405, processor(s) 1410, memory 1435, wireless communication interface 1433, and/or other components of computer system 1400, as illustrated in FIG. 14.

In some embodiments, blocks 1220, 1230, and 1240 may be performed according to the FDOA-based sensing configuration. For example, the receiver may transmit the frequency offsets to the server and the server may determine the FDOA measurements based on the frequency offsets as disclosed above. Additionally or alternatively, the receiver may determine the FDOA measurements based on the frequency offsets as disclosed above and transmit the FDOA measurements to the server. In some embodiments, the receiver and/or the server may determine the location and the Doppler information of the target (e.g., the transmitting device) based on the FDOA measurements. In some embodiments, the determination (e.g., the location and the Doppler information of the target) may be shared with/transmitted to the receiver and/or the server.

In some embodiments, prior to block 1210, method 1200 may also include receiving, from the transmitting device, a request for performing the FDOA-based sensing, wherein sending the FDOA-based sensing configuration is responsive to receiving the request.

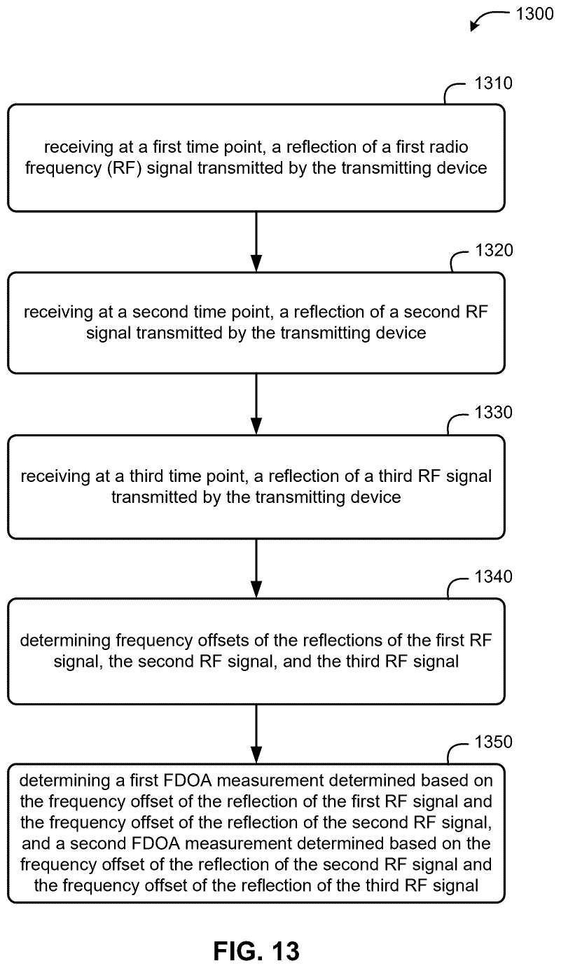

FIG. 13 is a flow diagram of a method 1300 of an improved FDOA-based sensing for sensing a transmitting device performed by a receiving device, according to an embodiment. In some embodiments, the receiving device may correspond to receiver 820 in FIG. 8 and/or sensing node 915 in FIG. 9. Means for performing the functionality illustrated in one or more of the blocks shown in FIG. 13 may be performed by hardware and/or software components of a base station. Example components of base station 120 are illustrated in FIG. 15, which is described in more detail below.

At block 1310, the functionality comprises receiving at a first time point corresponding to timestamp t₁, a reflection of a first radio frequency (RF) signal transmitted by the transmitting device. Means for performing functionality at block 1310 may comprise a bus 1505, processor(s) 1510, memory 1560, wireless communication interface 1530, and/or other components of base station 120, as illustrated in FIG. 15.

At block 1320, the functionality comprises receiving at a second time point corresponding to timestamp t₂, a reflection of a second RF signal transmitted by the transmitting device. Means for performing functionality at block 1320 may comprise a bus 1505, processor(s) 1510, memory 1560, wireless communication interface 1530, and/or other components of base station 120, as illustrated in FIG. 15.

At block 1330, the functionality comprises receiving at a third time point corresponding to timestamp t₃, a reflection of a third RF signal transmitted by the transmitting device. Means for performing functionality at block 1330 may comprise a bus 1505, processor(s) 1510, memory 1560, wireless communication interface 1530, and/or other components of base station 120, as illustrated in FIG. 15.

As noted above, in some embodiments, the different time points (e.g., corresponding to timestamps t₁, t₂, and t₃ respectively) may be selected from a predetermined time window T.

At block 1340, the functionality comprises determining frequency offsets of the reflections of the first RF signal, the second RF signal, and the third RF signal. Means for performing functionality at block 1340 may comprise a bus 1505, processor(s) 1510, memory 1560, wireless communication interface 1530, and/or other components of base station 120, as illustrated in FIG. 15.

At block 1350, the functionality comprises determining a first FDOA measurement determined based on the frequency offset of the reflection of the first RF signal and the frequency offset of the reflection of the second RF signal, and a second FDOA measurement determined based on the frequency offset of the reflection of the second RF signal and the frequency offset of the reflection of the third RF signal. Means for performing functionality at block 1350 may comprise a bus 1505, processor(s) 1510, memory 1560, wireless communication interface 1530, and/or other components of base station 120, as illustrated in FIG. 15.

In some embodiments, prior to block 1310, method 1300 may also include receiving, from a server, a FDOA-based sensing configuration, wherein the receiving device receives the first, the second, and the third RF signals in accordance with the FDOA-based sensing configuration.

In some embodiments, blocks 1340 and 1350 may be performed according to the FDOA-based sensing configuration. For example, the receiver may transmit the frequency offsets to the server and the server may determine the FDOA measurements based on the frequency offsets as disclosed above. Additionally or alternatively, the receiver may determine the FDOA measurements based on the frequency offsets as disclosed above and transmit the FDOA measurements to the server. In some embodiments, the receiver and/or the server may determine the location and the Doppler information of the target (e.g., the transmitting device) based on the FDOA measurements. In some embodiments, the determination (e.g., the location and the Doppler information of the target) may be shared with/transmitted to the receiver and/or the server.

FIG. 14 is a block diagram of an embodiment of a computer system 1400, which may be used, in whole or in part, to provide the functions of one or more network components as described in the embodiments herein (e.g., location server 160 of FIGS. 5-9 and 12). It should be noted that FIG. 14 is meant only to provide a generalized illustration of various components, any or all of which may be utilized as appropriate. FIG. 14, therefore, broadly illustrates how individual system elements may be implemented in a relatively separated or relatively more integrated manner. In addition, it can be noted that components illustrated by FIG. 14 can be localized to a single device and/or distributed among various networked devices, which may be disposed at different geographical locations.

The computer system 1400 is shown comprising hardware elements that can be electrically coupled via a bus 1405 (or may otherwise be in communication, as appropriate). The hardware elements may include processor(s) 1410, which may comprise without limitation one or more general-purpose processors, one or more special-purpose processors (such as digital signal processing chips, graphics acceleration processors, and/or the like), and/or other processing structure, which can be configured to perform one or more of the methods described herein. The computer system 1400 also may comprise one or more input devices 1415, which may comprise without limitation a mouse, a keyboard, a camera, a microphone, and/or the like; and one or more output devices 1420, which may comprise without limitation a display device, a printer, and/or the like.

The computer system 1400 may further include (and/or be in communication with) one or more non-transitory storage devices 1425, which can comprise, without limitation, local and/or network accessible storage, and/or may comprise, without limitation, a disk drive, a drive array, an optical storage device, a solid-state storage device, such as a RAM and/or ROM, which can be programmable, flash-updateable, and/or the like. Such storage devices may be configured to implement any appropriate data stores, including without limitation, various file systems, database structures, and/or the like. Such data stores may include database(s) and/or other data structures used store and administer messages and/or other information to be sent to one or more devices via hubs, as described herein.

The computer system 1400 may also include a communications subsystem 1430, which may comprise wireless communication technologies managed and controlled by a wireless communication interface 1433, as well as wired technologies (such as Ethernet, coaxial communications, universal serial bus (USB), and the like). The wireless communication interface 1433 may comprise one or more wireless transceivers that may send and receive wireless signals 1455 (e.g., signals according to 5G NR or LTE) via wireless antenna(s) 1450. Thus the communications subsystem 1430 may comprise a modem, a network card (wireless or wired), an infrared communication device, a wireless communication device, and/or a chipset, and/or the like, which may enable the computer system 1400 to communicate on any or all of the communication networks described herein to any device on the respective network, including a User Equipment (UE), base stations and/or other TRPs, and/or any other electronic devices described herein. Hence, the communications subsystem 1430 may be used to receive and send data as described in the embodiments herein.

In many embodiments, the computer system 1400 will further comprise a working memory 1435, which may comprise a RAM or ROM device, as described above. Software elements, shown as being located within the working memory 1435, may comprise an operating system 1440, device drivers, executable libraries, and/or other code, such as one or more applications 1445, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a non-transitory computer-readable storage medium, such as the storage device(s) 1425 described above. In some cases, the storage medium might be incorporated within a computer system, such as computer system 1400. In other embodiments, the storage medium might be separate from a computer system (e.g., a removable medium, such as an optical disc), and/or provided in an installation package, such that the storage medium can be used to program, configure, and/or adapt a general purpose computer with the instructions/code stored thereon. These instructions might take the form of executable code, which is executable by the computer system 1400 and/or might take the form of source and/or installable code, which, upon compilation and/or installation on the computer system 1400 (e.g., using any of a variety of generally available compilers, installation programs, compression/decompression utilities, etc.), then takes the form of executable code.

FIG. 15 is a block diagram of an embodiment of a base station 120, which can be utilized as described herein above (e.g., in association with FIGS. 5-10 and 12). It should be noted that FIG. 15 is meant only to provide a generalized illustration of various components, any or all of which may be utilized as appropriate. In some embodiments, the base station 120 may correspond to a gNB, an ng-eNB, and/or (more generally) a TRP.

The base station 120 is shown comprising hardware elements that can be electrically coupled via a bus 1505 (or may otherwise be in communication, as appropriate). The hardware elements may include a processor(s) 1510 which can include without limitation one or more general-purpose processors, one or more special-purpose processors (such as DSP chips, graphics acceleration processors, ASICs, and/or the like), and/or other processing structure or means. As shown in FIG. 15, some embodiments may have a separate DSP 1520, depending on desired functionality. Location determination and/or other determinations based on wireless communication may be provided in the processor(s) 1510 and/or wireless communication interface 1530 (discussed below), according to some embodiments. The base station 120 also can include one or more input devices, which can include without limitation a keyboard, display, mouse, microphone, button(s), dial(s), switch(es), and/or the like; and one or more output devices, which can include without limitation a display, light emitting diode (LED), speakers, and/or the like.

The base station 120 might also include a wireless communication interface 1530, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, cellular communication facilities, etc.), and/or the like, which may enable the base station 120 to communicate as described herein. The wireless communication interface 1530 may permit data and signaling to be communicated (e.g., transmitted and received) to UEs, other base stations/TRPs (e.g., eNBs, gNBs, and ng-eNBs), and/or other network components, computer systems, and/or any other electronic devices described herein. The communication can be carried out via one or more wireless communication antenna(s) 1532 that send and/or receive wireless signals 1534.

The base station 120 may also include a network interface 1580, which can include support of wireline communication technologies. The network interface 1580 may include a modem, network card, chipset, and/or the like. The network interface 1580 may include one or more input and/or output communication interfaces to permit data to be exchanged with a network, communication network servers, computer systems, and/or any other electronic devices described herein.

In many embodiments, the base station 120 may further comprise a memory 1560. The memory 1560 can include, without limitation, local and/or network accessible storage, a disk drive, a drive array, an optical storage device, a solid-state storage device, such as a RAM, and/or a ROM, which can be programmable, flash-updateable, and/or the like. Such storage devices may be configured to implement any appropriate data stores, including without limitation, various file systems, database structures, and/or the like.

The memory 1560 of the base station 120 also may comprise software elements (not shown in FIG. 15), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 1560 that are executable by the base station 120 (and/or processor(s) 1510 or DSP 1520 within base station 120). In some embodiments, then, such code and/or instructions can be used to configure and/or adapt a general-purpose computer (or other device) to perform one or more operations in accordance with the described methods.

It will be apparent to those skilled in the art that substantial variations may be made in accordance with specific requirements. For example, customized hardware might also be used and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processors and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media and volatile media. Common forms of computer-readable media include, for example, magnetic and/or optical media, any other physical medium with patterns of holes, a RAM, a programmable ROM (PROM), erasable PROM (EPROM), a FLASH-EPROM, any other memory chip or cartridge, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussion utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the scope of the disclosure. For example, the above elements may merely be a component of a larger system, wherein other rules may take precedence over or otherwise modify the application of the various embodiments. Also, a number of steps may be undertaken before, during, or after the above elements are considered. Accordingly, the above description does not limit the scope of the disclosure.

In view of this description embodiments may include different combinations of features. Implementation examples are described in the following numbered clauses:
Clause 1. A method of frequency difference of arrival (FDOA)-based sensing transmitting device, performed by a server, the method comprising transmitting, to the transmitting device, a FDOA-based sensing configuration, wherein the FDOA-based sensing configuration configures the transmitting device to: transmit at a first time point, a first radio frequency (RF) signal; transmit at a second time point, a second RF signal; and transmit at a third time point, a third RF signal. The method also comprises obtaining a first FDOA measurement determined based on a reflection of the first RF signal and a reflection of the second RF signal, and a second FDOA measurement determined based on the reflection of the second RF signal and a reflection of the third RF signal, wherein the reflections of the first, the second, and the third RF signals are reflected by a reflector and received at a receiving device. The method further comprises obtaining Doppler information of the reflector; and obtaining Doppler information of the transmitting device based on the first FDOA measurement and the second FDOA measurement, and the Doppler information of the reflector.
Clause 2. The method of clause 1, further comprising: determining a location and a speed of the transmitting device based on the Doppler information of the transmitting device.
Clause 3. The method of any of clause 1 or 2, wherein the first, the second, and the third time points are selected from a predetermined time window.
Clause 4. The method of any of clauses 1-3, further comprising: receiving, from the transmitting device, a request for performing the FDOA-based sensing, wherein sending the FDOA-based sensing configuration is responsive to receiving the request
Clause 5. The method of any of clauses 1-4, further comprising: obtaining, from the receiving device, frequency offsets of the reflections, wherein obtaining the first FDOA measurement and the second FDOA measurement further comprises: determining a frequency difference between a frequency offset of the reflection of the first RF signal and a frequency offset of the reflection of the second RF signal, and the second FDOA measurement determined from a frequency difference between a frequency offset of the reflection of the second RF signal and a frequency offset of the reflection of the third RF signal.
Clause 6. The method of any of clauses 1-5, wherein obtaining the Doppler information of the transmitting device further comprises: determining the Doppler information based on the first FDOA measurement and the second FDOA measurement.
Clause 7. The method of any of clauses 1-6, wherein the reflector comprises a reconfigurable intelligent surface (RIS).
Clause 8. A method of frequency difference of arrival (FDOA)-based sensing for a transmitting device performed by a receiving device, the method comprising receiving at a first time point, a reflection of a first radio frequency (RF) signal transmitted by the transmitting device and receiving at a second time point, a reflection of a second RF signal transmitted by the transmitting device. The method also comprises receiving at a third time point, a reflection of a third RF signal transmitted by the transmitting device and determining frequency offsets of the reflections of the first RF signal, the second RF signal, and the third RF signal. The method further comprises determining a first FDOA measurement determined based on the frequency offset of the reflection of the first RF signal and the frequency offset of the reflection of the second RF signal, and a second FDOA measurement determined based on the frequency offset of the reflection of the second RF signal and the frequency offset of the reflection of the third RF signal.
Clause 9. The method of clause 8, wherein the first, the second, and the third time points are selected from a predetermined time window.
Clause 10. The method of any of clause 8 or 9, further comprising: receiving, from a server, a FDOA-based sensing configuration, wherein the receiving device receives the first, the second, and the third RF signals in accordance with the FDOA-based sensing configuration.
Clause 11. The method of any of clauses 8-10, further comprising: transmitting, to the server, the first and the second FDOAs for determining Doppler information of the transmitting device.
Clause 12. The method of any of clauses 8-11, further comprising: determining, Doppler information of the transmitting device based on the first and the second FDOAs.
Clause 13. The method of any of clauses 8-12, wherein the reflections of the first, the second, and the third RF signals are reflected by a reflector with known Doppler information.
Clause 14. A server for frequency difference of arrival (FDOA)-based sensing of a target, the server comprising a transceiver, a memory, and one or more processors communicatively coupled with the transceiver and the memory. The one or more processors are configured to transmit, to the transmitting device, a FDOA-based sensing configuration, wherein the FDOA-based sensing configuration configures the transmitting device to: transmit at a first time point, a first radio frequency (RF) signal, transmit at a second time point, a second RF signal, and transmit at a third time point, a third RF signal. The one or more processors are also configured to obtain a first FDOA measurement determined based on a reflection of the first RF signal and a reflection of the second RF signal, and a second FDOA measurement determined based on the reflection of the second RF signal and a reflection of the third RF signal, wherein the reflections of the first, the second, and the third RF signals are reflected by a reflector and received at a receiving device. The one or more processors are further configured to obtain Doppler information of the reflector and obtain Doppler information of the transmitting device based on the first FDOA measurement and the second FDOA measurement, and the Doppler information of the reflector.
Clause 15. The server of clause 14, wherein the one or more processors are further configured to: determine a location and a speed of the target based on the Doppler information of the target.
Clause 16. The server of any of clause 14 or 15, wherein the first, the second, and the third time points are selected from a predetermined time window.
Clause 17. The server of any of clauses 14-16, wherein the one or more processors are further configured to: receive, from the transmitting device, a request for performing the FDOA-based sensing, wherein sending the FDOA-based sensing configuration is responsive to receiving the request.
Clause 18. The server of any of clauses 14-17, wherein the one or more processors are further configured to: obtain, from the receiving device, frequency offsets of the reflections, wherein obtaining the first FDOA measurement and the second FDOA measurement further comprises: determine a frequency difference between a frequency offset of the reflection of the first RF signal and a frequency offset of the reflection of the second RF signal, and the second FDOA measurement determined from a frequency difference between a frequency offset of the reflection of the second RF signal and a frequency offset of the reflection of the third RF signal.
Clause 19. The server of any of clauses 14-18, wherein the one or more processors are further configured to: determine the Doppler information based on the first and the second FDOA measurements.
Clause 20. The server of any of clauses 14-19, wherein the reflector comprises a reconfigurable intelligent surface (RIS).
Clause 21. A device for frequency difference of arrival (FDOA)-based sensing of a target, the device comprising a transceiver, a memory, and one or more processors communicatively coupled with the transceiver and the memory. The one or more processors are configured to receive at a first time point, a reflection of a first radio frequency (RF) signal transmitted by the transmitting device and receive at a second time point, a reflection of a second RF signal transmitted by the transmitting device. The one or more processors are further configured to receive at a third time point, a reflection of a third RF signal transmitted by the transmitting device and determine frequency offsets of the reflections of the first RF signal, the second RF signal, and the third RF signal. The one or more processors are further configured to determine a first FDOA measurement determined based on the frequency offset of the reflection of the first RF signal and the frequency offset of the reflection of the second RF signal, and a second FDOA measurement determined based on the frequency offset of the reflection of the second RF signal and the frequency offset of the reflection of the third RF signal.
Clause 22. The device of clause 21, wherein the first, the second, and the third time points are selected from a predetermined time window.
Clause 23. The device of any of clause 21 or 22, wherein the one or more processors are further configured to: receive, from a server, a FDOA-based sensing configuration, wherein the receiving device receives the first, the second, and the third RF signals in accordance with the FDOA-based sensing configuration.
Clause 24. The device of any of clauses 21-23, wherein the one or more processors are further configured to: transmit, to the server, the first and the second FDOAs for determining Doppler information of the transmitting device.
Clause 25. The device of any of clauses 21-24, wherein the one or more processors are further configured to: determine, Doppler information of the transmitting device based on the first and the second FDOAs.
Clause 26. The device of any of clauses 21-25, wherein the reflections of the first, the second, and the third RF signals are reflected by a reflector with known Doppler information.

1-7. (canceled)

8. A method of frequency difference of arrival (FDOA)-based sensing for a transmitting device performed by a receiving device, the method comprising:
receiving at a first time point, a reflection of a first radio frequency (RF) signal transmitted by the transmitting device;
receiving at a second time point, a reflection of a second RF signal transmitted by the transmitting device;
receiving at a third time point, a reflection of a third RF signal transmitted by the transmitting device;
determining frequency offsets of the reflections of the first RF signal, the second RF signal, and the third RF signal; and
determining a first FDOA measurement determined based on the frequency offset of the reflection of the first RF signal and the frequency offset of the reflection of the second RF signal, and a second FDOA measurement determined based on the frequency offset of the reflection of the second RF signal and the frequency offset of the reflection of the third RF signal.

9. The method of claim 8, wherein the first, the second, and the third time points are selected from a predetermined time window.

10. The method of claim 8, further comprising:
receiving, from a server, a FDOA-based sensing configuration, wherein the receiving device receives the first, the second, and the third RF signals in accordance with the FDOA-based sensing configuration.

11. The method of claim 10, further comprising:
transmitting, to the server, the first and the second FDOAs for determining Doppler information of the transmitting device.

12. The method of claim 10, further comprising:
determining, Doppler information of the transmitting device based on the first and the second FDOAs.

13. The method of claim 8, wherein the reflections of the first, the second, and the third RF signals are reflected by a reflector with known Doppler information.

14. A server for frequency difference of arrival (FDOA)-based sensing of a transmitting device, the server comprising:
a transceiver;
a memory; and
one or more processors communicatively coupled with the transceiver and the memory, wherein the one or more processors are configured to:
transmit, to the transmitting device, a FDOA-based sensing configuration, wherein the FDOA-based sensing configuration configures the transmitting device to:
transmit at a first time point, a first radio frequency (RF) signal;
transmit at a second time point, a second RF signal; and
transmit at a third time point, a third RF signal;
obtain a first FDOA measurement determined based on a reflection of the first RF signal and a reflection of the second RF signal, and a second FDOA measurement determined based on the reflection of the second RF signal and a reflection of the third RF signal, wherein the reflections of the first, the second, and the third RF signals are reflected by a reflector and received at a receiving device;
obtain Doppler information of the reflector; and
obtain Doppler information of the transmitting device based on the first FDOA measurement and the second FDOA measurement, and the Doppler information of the reflector.

15. The server of claim 14, wherein the one or more processors are further configured to:
determine a location and a speed of the target based on the Doppler information of the target.

16. The server of claim 14, wherein the first, the second, and the third time points are selected from a predetermined time window.

17. The server of claim 14, wherein the one or more processors are further configured to:
receive, from the transmitting device, a request for performing the FDOA-based sensing, wherein sending the FDOA-based sensing configuration is responsive to receiving the request.

18. The server of claim 14, wherein the one or more processors are further configured to:
obtain, from the receiving device, frequency offsets of the reflections, wherein obtaining the first FDOA measurement and the second FDOA measurement further comprises:
determine a frequency difference between a frequency offset of the reflection of the first RF signal and a frequency offset of the reflection of the second RF signal, and the second FDOA measurement determined from a frequency difference between a frequency offset of the reflection of the second RF signal and a frequency offset of the reflection of the third RF signal.

19. The server of claim 14, wherein the one or more processors are further configured to:
determine the Doppler information based on the first and the second FDOA measurements.

20. The server of claim 14, wherein the reflector comprises a reconfigurable intelligent surface (RIS).

21. A device for frequency difference of arrival (FDOA)-based sensing of a transmitting device, the device comprising:
a transceiver;
a memory; and
one or more processors communicatively coupled with the transceiver and the memory, wherein the one or more processors are configured to:
receive at a first time point, a reflection of a first radio frequency (RF) signal transmitted by the transmitting device;
receive at a second time point, a reflection of a second RF signal transmitted by the transmitting device;
receive at a third time point, a reflection of a third RF signal transmitted by the transmitting device;
determine frequency offsets of the reflections of the first RF signal, the second RF signal, and the third RF signal; and
determine a first FDOA measurement determined based on the frequency offset of the reflection of the first RF signal and the frequency offset of the reflection of the second RF signal, and a second FDOA measurement determined based on the frequency offset of the reflection of the second RF signal and the frequency offset of the reflection of the third RF signal.

22. The device of claim 21, wherein the first, the second, and the third time points are selected from a predetermined time window.

23. The device of claim 21, wherein the one or more processors are further configured to:
receive, from a server, a FDOA-based sensing configuration, wherein the device receives the first, the second, and the third RF signals in accordance with the FDOA-based sensing configuration.

24. The device of claim 23, wherein the one or more processors are further configured to:
transmit, to the server, the first and the second FDOAs for determining Doppler information of the transmitting device.

25. The device of claim 23, wherein the one or more processors are further configured to:
determine, Doppler information of the transmitting device based on the first and the second FDOAs.

26. The device of claim 21, wherein the reflections of the first, the second, and the third RF signals are reflected by a reflector with known Doppler information.
